(19) United States
(12) Patent Application Publication
(10) Pub. No.: US 2015/0253591 A1
(43) Pub. Date: Sep. 10, 2015

(54) DYE COMPOSITION FOR ELECTROWETTING DISPLAY AND ELECTROWETTING DISPLAY DEVICE

(71) Applicant: FUJIFILM CORPORATION, Tokyo (JP)

(72) Inventors: Takashi KATO, Shizuoka-ken (JP); Satoshi HIGUCHI, Shizuoka-ken (JP)

(21) Appl. No.: 14/718,087

(22) Filed: May 21, 2015

Related U.S. Application Data
(63) Continuation of application No. PCT/JP2013/080157, filed on Nov. 7, 2013.

(30) Foreign Application Priority Data
Nov. 27, 2012 (JP) 2012-259175

(51) Int. Cl. G02F 1/00; C09B 23/14; C09B 47/30; G02B 26/00

(52) U.S. Cl. CPC G02F 1/0018; G02B 26/005; C09B 23/145; C09B 47/30

(57) ABSTRACT

A dye composition for an electrowetting display, comprising: an ether-based nonpolar solvent having a relative dielectric constant of 5 or less; and a dye at a content of 10% by mass or more with respect to a total mass of the dye composition.

### CROSS-REFERENCE TO RELATED APPLICATION

This application is a continuation application of International Application No. PCT/JP2013/080157, filed Nov. 7, 2013, the disclosure of which is incorporated herein by reference in its entirety. Further, this application claims priority from Japanese Patent Application No. 2012-259175, filed Nov. 27, 2012, the disclosure of which is incorporated herein by reference in its entirety.

### TECHNICAL FIELD

The present invention relates to a dye composition for an electrowetting display, and an electrowetting display device.

### BACKGROUND ART

Studies on an optical device, which is provided with a cell containing 2 or more kinds of mutually immiscible liquids (for example, 2 liquids of an oil and a hydrophilic liquid) and driven by applying a voltage, have been heretofore carried out. As such an optical device, for example, a light shutter, a variable-focus lens, and an image display device have been known, and especially a technology utilizing an electrowetting phenomenon has drawn attention recently.

As an example of a technology utilizing an electrowetting phenomenon, an electrowetting display provided with a first substrate and a second substrate placed opposite to each other, plural projections defining plural pixel units, and a non-electroconductive first fluid and an electroconductive or polar second fluid immiscible mutually with the first fluid, both of the first fluid and the second fluid are encapsulated in a pixel unit between adjacent 2 projections, has been known (refer to, for example, Japanese Patent Application Laid-Open (JP-A) No. 2009-86668).

Further, a colored fluid for an electrowetting device containing a nonaqueous polar solvent, such as a glycol, an alcohol, an ether, and an ester, and a colorant has been disclosed (refer to, for example, JP-A No. 2012-520485). In this case it is recommended as preferable that the nonaqueous polar solvent should have a dielectric constant larger than 10, and the colored fluid should have an electric conductivity larger than 5 μS/cm,

Furthermore, it has been disclosed that decane is use as a nonpolar fluid constituting an electrowetting device (refer, for example, to Pamphlet of International Publication No. WO 2008/142086). Further, it has been disclosed that a display ink for displaying an image by an electrowetting method, etc. is constituted with a pigment and a low polarity solvent, and that as the low polarity solvent a hydrocarbon solvent, a fluorocarbon solvent, a silicone oil, a higher fatty acid ester, etc. are used (refer to, for example, Pamphlet of International Publication No. WO 0011/111710).

### SUMMARY OF INVENTION

### Technical Problem

An electrowetting display is one of display technologies which have been recently drawing attention as an image displaying medium. In order to be positioned as a displaying medium replacing a paper medium, etc., it is required that the display speed in displaying an image, the density of a displayed image (discriminability), and density uniformity are favorable, and that the medium is endowed with a retentive ability for keeping a once displayed image in a constant state.

Among these, the requirements for density of a displayed image (discriminability), density uniformity, display speed (i.e. image formation property), and stability of a once displayed image are severe.

In order to develop sufficiently the density of an image displayed in an electrowetting display, it is necessary to increase the color density of an oil responsible for imaging, namely the concentration of a coloring material contained in an oil. As a coloring material for an oil, a dye is usually used, however, in some cases, the solubility of a dye in a nonpolar solvent constituting an oil phase is insufficient. Therefore, it is difficult to increase the dye concentration to a range suitable for image display, while maintaining favorable display characteristics. Meanwhile, when a dye having high solubility in a nonpolar solvent is used, the color density of an oil itself is improved indeed, however if the dye amount in an oil becomes too much, the dynamic sensitivity (responsiveness) of an oil during voltage application easily decreases and the image formation property tends to deteriorate significantly.

With respect to a nonpolar solvent, it is important not only that the same dissolves a dye well, but also that the same changes hardly the composition of an oil phase with a change in a temperature environment. In other words, it is preferable that a nonpolar solvent is hard to evaporate in a relatively high temperature environment, so as to keep a predetermined dye concentration, etc.; the solvent itself is hard to thicken or solidify and the solvent does not impair the solubility of a dye or the responsiveness of an oil in a low temperature environment.

In the prior art described above, JP-A No. 2012-520485 describes a colored fluid for an electrowetting device using a solvent, wherein the colored fluid containing a colorant is prepared with a polar solvent. The colored fluid is, however, not related at all to a non-electroconductive oil to be placed between a hydrophilic liquid having polarity and a hydrophobic insulating film, and different from a constitution in which a nonpolar solvent has a strong influence on an image display.

Further, in the case of a solvent described in Pamphlet of International Publication No. WO 2008/142086 and Pamphlet of International Publication No. WO 2011/111710, the stability of interfaces between either of a hydrophilic liquid or a hydrophobic insulating film, and an oil placed between them may be sometimes hardly maintained satisfactory.

As described above, despite various investigations made heretofore on an electrowetting display, a technology for securing the density uniformity of a display image (absence of density unevenness), while improving image display qualities, such as display density of an image, display speed, and display stability after displaying, has not been established yet. Further, an image display technology, which can maintain stably image display qualities irrespective of difference in an environmental temperature, has been demanded.

The present invention was made in view of such circumstances, with an object to provide a dye composition for an electrowetting display, which has superior responsiveness in displaying an image and high optical density, and yields an image with little density unevenness.

Another object of the invention is to provide an electrowetting display device which yields an image having superior responsiveness in displaying an image, high optical density, and little density unevenness.

### Solution to Problem

The inventors made the following findings and the present invention was achieved based on the knowledge.

High solubility of a dye in a solvent constituting an oil phase contributory to imaging is advantageous for improvement of display characteristics, such as display image density, and responsiveness in displaying an image. However, it is not desirable that the oil lacks affinities with the two, which will cause repellence of the oil and lead to density unevenness due to the constitution in which an oil is placed between a hydrophilic liquid and a hydrophobic insulating film.

Further, it is also not desirable that a solvent itself easily changes by a change in the temperature of a service environment of a display device. A solvent of an oil phase responsible for imaging has desirably such thermal characteristics, that, for example, when exposed to a high temperature environment, the evaporation amount is small, the relative contents change little, and conversely when exposed to a low temperature environment, the solvent does not thicken or solidify, the solubility of a solute such as a dye is maintained, and the flowability is maintained stably.

Further, it is desirable that once displayed, a backflow of the displayed image does not occur easily. A back flow means a phenomenon that the area of an oil, which has been contracted and reduced when a voltage is applied and kept, increases over time.

Specific means of the invention are as follows.

### Advantageous Effects of Invention

According to the invention, a dye composition for an electrowetting display, which has superior responsiveness in displaying an image and high optical density, and yields an image with little density unevenness, is provided.

Further, according to the invention an electrowetting display device, which has superior responsiveness in displaying an image and high optical density, and yields an image with little density unevenness, is provided.

### BRIEF DESCRIPTION OF DRAWINGS

FIG. 1 is a schematic cross-sectional view of an electrowetting display device according to an embodiment of the invention when the voltage is OFF.

FIG. 2 is a schematic cross-sectional view of an electrowetting display device according to an embodiment of the invention when the voltage is ON.

FIG. 3 is a photograph showing a state of an oil layer formed by applying a dye ink P1 according to Example on to a hydrophobic insulating film (fluoropolymer layer).

FIG. 4 is a photograph showing a state of an oil layer formed by applying a dye ink D1 according to Comparative Example on to a hydrophobic insulating film (fluoropolymer layer).

### DESCRIPTION OF EMBODIMENTS

A dye composition for an electrowetting display according to the invention will be described in detail below, and an embodiment of an electrowetting display device will be also described in detail referring to drawings; provided that the invention be not limited to a specific Embodiment presented below.

A dye composition for an electrowetting display according to the invention contains an ether-based nonpolar solvent with a relative dielectric constant of 5 or less, and a dye at a content of 10% by mass or more with respect to the total mass of the dye composition. The dye composition may contain, if necessary, additionally various additives, such as a surfactant, a UV absorber, and an antioxidant.

A dye composition for an electrowetting display according to the invention is used as an oil constituting an electrowetting display device as described below. A dye composition for an electrowetting display according to the invention is hereinafter occasionally referred to simply as “dye composition” or “oil”.

In a display technology utilizing an electrowetting phenomenon, image display is performed generally by moving an oil phase (layer), and the oil phase (layer) using a nonpolar solvent contains a coloring material. However, since the solubility of a dye in a nonpolar solvent is generally low, unless the the solubility of a dye is secured, the mobility (responsiveness) of an oil phase in displaying an image may decrease, or a disorder of an image due to a backflow may occur, when a state in which a voltage is applied and an image displayed is maintained. Such a kind of solvent, that cannot maintain the image formation property favorable, is not suitable for a display utilizing an electrowetting phenomenon.

In an electrowetting display device, an oil phase is placed in contact with a surface of a hydrophilic liquid, and in a case in which the affinity of a nonpolar solvent contained in an oil phase for a hydrophilic liquid and for a hydrophobic insulating film is low, the oil phase can hardly spread uniformly over a surface of the hydrophobic insulating film, and may be even repelled such that an oil layer with a uniform thickness is not formed and density unevenness takes place.

From the above viewpoint, in a dye composition according to the invention, an ether-based nonpolar solvent with a relative dielectric constant of 5 or less is used especially as a solvent constituting an oil phase to be used for an electrowetting display, and therein 10% by mass or more of a dye is dissolved to form a composition. By the above means, a highly uniform oil layer can be formed, such that despite a relatively high content of a dye as high as 10% by mass or more, the solubility is secured and repellence scarcely takes place, when an oil layer is provided between a hydrophilic liquid and a hydrophobic insulating film.

Although the reason why a dye composition according to the invention provides a highly uniform oil layer is not very clear, it is presumed as follows. Namely, when an ether-based nonpolar solvent with a relative dielectric constant of 5 or less, for example, an alkyl ether, is used as a solvent, the alkyl ether existing between a polymer component constituting a hydrophobic insulating film, which is a water-repellent film, and a solvent of a hydrophilic liquid (for example, ethylene glycol), an alkyl moiety of the alkyl ether interacts with a polymer component, and meanwhile an oxygen atom of an ether in the alkyl ether interacts with a solvent of a hydrophilic liquid, and therefore, conceivably, an oil thin film can exist stably. On the other hand, when decane having been used conventionally is used as a solvent, the stability is low especially at an interface between an oil phase and a hydrophilic solvent, and therefore an oil phase phase is apt to be repelled by a hydrophilic solvent, and consequently a thin film on a surface of a uniform hydrophobic insulating film is hardly obtained, which conceivably results in density unevenness.

As described above, when a dye composition according to the invention is used as an oil phase for constituting an electrowetting display device, the device can be superior in responsiveness in displaying an image, and a displayed image can exhibit high density with only suppressed unevenness. Further, a backflow phenomenon can be also suppressed in a voltage-applied state.

As described above, display characteristics of an image according to the invention are superior to a conventional electrowetting display device.

Each component constituting a dye composition for an electrowetting display according to the invention will be described in detail below.

### <Ether-Based Nonpolar Solvent>

A dye composition for an electrowetting display according to the invention contains at least one kind of ether-based nonpolar solvent with a relative dielectric constant (∈ᵣ) of 5 or less. A nonpolar solvent means a solvent with a small relative dielectric constant value (also called as a polar solvent). Especially, an ether-based solvent whose relative dielectric constant falls within a range of 5 or less is used.

Since a dye composition according to the invention contains such an ether-based nonpolar solvent, the solubility of a dye is stably secured, and the solvent has affinity for both a hydrophobic insulating film and a hydrophilic liquid, and therefore when an oil layer is formed, repellence occurs not easily to yield a highly uniform oil layer. As the result, an image whose optical density of a display image is highly uniform, and density unevenness is little, can be obtained. Consequently, a dye composition according to the invention is superior in responsiveness in displaying an image, and able to maintain stably image display characteristics irrespective of a temperature change in a service environment.

A dye composition for an electrowetting display according to the invention is constituted as a non-electroconductive oil using an ether-based nonpolar solvent together with a dye as described below. Non-electroconductivity means a property that specific resistance is 10⁶ Ω·cm or more (preferably 10⁷ Ω·cm or more). The electric conductivity of a dye composition according to the invention is adjusted to 5 μS/cm or less.

The relative dielectric constant of the ether-based nonpolar solvent in a range of 5 or less is preferably in a range from 1 to 5, more preferably in a range from 2 to 4, and further preferably in a range from 2 to 3. When the relative dielectric constant exceeds 5, the polarity becomes too strong, and the response speed in displaying an image deteriorates, such that a drive (operation) at a low voltage becomes disadvantageous.

The relative dielectric constant is determined by injecting a nonpolar solvent in a glass cell with a 10-μm cell gap provided with an ITO transparent electrode, and measuring the electrical capacity of the obtained cell using a 2353LCR METER manufactured by NF Corporation (measurement frequency: 1 kHz) at 20° C. and 40% RH.

The boiling point of the ether-based nonpolar solvent is preferably 180° C. or more. Since the boiling point is relatively high such as 180° C. or more, even when exposed to a high temperature environment, evaporation of the solvent from an oil is little and the oil composition can be maintained stably. Thereby, deterioration of the display image quality can be suppressed and stabilization of display characteristics is attained. The boiling point is more preferably 182° C. or more, and further preferably 184° C. or more. Although there is no particular restriction on the upper limit of the boiling point, the upper limit is preferably 200° C.

The solidifying point of the ether-based nonpolar solvent is preferably −40° C. or below. In a case in which the solidifying point is relatively low such as −40° C. or below, even when exposed to a low temperature environment, solidification of a solvent in an oil, or precipitation of a dissolved component such as a dye can be suppressed, and the composition of an oil can be maintained stably. Thereby, deterioration of the display image quality can be suppressed and stabilization of display characteristics can be attained. The solidifying point is more preferably −42° C. or below, and further preferably −44° C. or below. Although there is no particular restriction on the lower limit of the boiling point, the lower limit is preferably −100° C.

The ether-based nonpolar solvent is preferably a compound having a symmetric structure. When there is a symmetric structure in a molecule, the dielectric constant becomes low, so that the responsiveness in displaying an image is superior. Further, backflow of a displayed image is effectively avoided.

There is no other particular restriction on the ether-based solvent in the invention, insofar as the relative dielectric constant is 5 or less, and the ether-based solvent may be selected according to an intended purpose. As the ether-based nonpolar solvent, a dialkyl ether is preferable, and specific examples thereof as an appropriate solvent include dihexyl ether (∈ᵣ=2.1), dipentyl ether (∈ᵣ=2.1), diheptyl ether (∈ᵣ=2.1), didodecyl ether (∈ᵣ=2.1), and dicyclohexyl ether (∈ᵣ=2.1).

The content of the ether-based nonpolar solvent in a dye composition (oil) with respect to the total mass of the dye composition (oil) is preferably 30% by mass or more, and more preferably 40% by mass or more. The upper limit of the content of the ether-based nonpolar solvent in a dye composition (oil) with respect to the total mass of the dye composition (oil) is preferably 90% by mass or less, and more preferably 80% by mass or less. When the content of the ether-based nonpolar solvent is 30% by or more, an improved light shutter characteristic is exhibited. Further, the solubility of a dye contained in the dye composition can be maintained at a more favorable level.

The dye composition for an electrowetting display (oil) may contain a nonpolar solvent other than the ether-based nonpolar solvent, or a polar solvent, to the extent advantageous effects of the invention are not impaired. In this case, the content of the ether-based nonpolar solvent in the dye composition with respect to the total solvent amount in the dye composition is preferably 70% by mass or more, and more preferably 90% by mass or more.

A dissolved oxygen contained in the nonpolar solvent is preferably in a range of 10 ppm or less. When the dissolved oxygen content exceeds 10 ppm, a dye tends to degrade and the responsiveness of an assembled electrowetting display device tends to deteriorate. A lower dissolved oxygen content is more preferable, and 8 ppm or less is more preferable.

<Dye>

The dye composition for an electrowetting display contains at least one kind of dye.

There is no particular restriction on the dye, insofar as the dye has solubility in the ether-based nonpolar solvent, and any one may be selected arbitrarily out of publicly known compounds. From a viewpoint of the responsiveness of an oil phase when a voltage is applied, the dye is preferably a dye having a solubility in dihexyl ether at 25° C., and 0.1 MPa of 1% by mass or more, and having superior solubility in a nonpolar solvent, especially in the ether-based nonpolar solvent. When the solubility is 1% by mass or more, the dye is suitable for an electrowetting display device. The solubility is preferably 3% by mass or more, and more preferably 5% by mass or more. Higher solubility is the more preferable, however the solubility is generally approx. 80% by mass or less.

The molecule weight of the dye is preferably in a relatively low molecule weight range such as from 50 to 2,000, more preferably in a range of from 300 to 2000, and further preferably in a range of from 500 to 1,500. When the molecule weight is 50 or more, the solubility in the ether-based nonpolar solvent can be secured, and when the molecule weight is 2,000 or less, the absorption intensity is high and the responsiveness in displaying an image can be maintained at a favorable level.

For the dye composition for an electrowetting display, a dye may be used singly, or in a in a combination of 2 or more kinds thereof.

The concentration of the dye contained in the dye composition with respect to the total amount of the dye composition is 10% by mass or more. That the concentration of the dye is 10% by mass or more means that the ether-based nonpolar solvent has dissolving power on a high concentration dye, and that an image can be displayed with relatively high density.

The concentration of the dye is preferably in a range of 20% by mass or more with respect to the total amount of the dye composition (oil) from a viewpoint of improved density, clarity, definition, etc. of a displayed image, more preferably in a range of 40% by mass or more, and further preferably in a range of 50% by mass or more. When the amount of the dye contained in the dye composition (oil) is increased, the responsiveness of the oil when a voltage is applied decreases, and also a backflow phenomenon in a voltage-applied state deteriorates, and therefore the image display quality tends to deteriorate. Consequently, especially with respect to the oil composition with a dye content of 10% by mass or more (preferably a range exceeding 20% by mass), advantageous effects of the invention can be favorably exhibited. Further, from a viewpoint of improved response speed, the dye concentration with respect to the total amount of the oil is preferably 80% by mass or less, more preferably 75% by mass or less, and further preferably 70% by mass or less.

A dye concentration (C) in the dye composition may be adjusted to an optional concentration according to an intended purpose. When a dye is used as a coloring matter for an electrowetting display, the dye is used as diluted in a nonpolar solvent according to a required ∈C value (=∈×C [∈: absorption coefficient of an oil]) and ordinarily at a concentration of 10% by mass or more.

Although there is no particular restriction on the molar absorption coefficient of a dye to be used according to the invention, it is preferably 30,000 or more, and especially preferably 50,000 or more. It is preferable that the molar absorption coefficient is 30,000 or more, because both high display quality and responsiveness can be secured easily.

As the dye, a dye including a structure having a relatively long-chain alkyl group with 6 to 30 carbon atoms is preferable, and a dye including a structure having an alkyl group with 6 to 20 carbon atoms is especially preferable. When a dye has an alkyl group with 6 to 30 carbon atoms in its structure, the solubility in the ether-based nonpolar solvent is improved, and the responsiveness is enhanced.

Preferable dyes will be outlined below.

Examples of preferable dyes include azo dyes, azomethine dyes, methine dyes, phthalocyanine dyes, porphyrin dyes, and anthraquinone dyes.

### 1. Azo Dye

Examples of azo dyes include those expressed by the following General Formula (1).

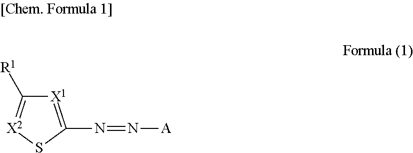

In Formula (1), A represents an aromatic group or a heterocyclic group; R¹ represents a hydrogen atom, an alkyl group, an alkoxy group, a cyano group, a carbonyl group, a halogen atom, an aromatic group, or a heterocyclic group; X¹ and X² independently represent —C(R²)=, or a nitrogen atom; R² represents a hydrogen atom, an alkyl group, an alkoxy group, a cyano group, a nitro group, a carbonyl group, an aromatic group, or a heterocyclic group; and R¹ and R² may jointly form a ring structure.

Among these, from a viewpoint of high solubility in the ether-based nonpolar solvent (solubility in dihexyl ether at 25° C. and 0.1 MPa is 1% by mass or more) and possibility of preparation of a dye composition with a high dye concentration, preferably at least one of R¹, X¹, X², and A has a alkyl group having 6 to 30 carbon atoms, but none of R¹, X¹, X², and A has a dissociable group or a halogen atom.

Among the azo dyes expressed by Formula (1), from a viewpoint of favorable solubility in an ether-based nonpolar solvent, a compound expressed by the following General Formula (1a) or the following General Formula (1b) is preferable.

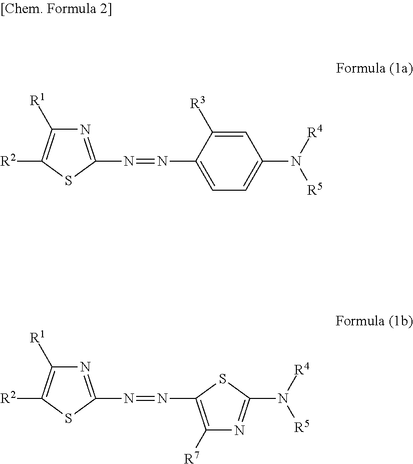

In Formulae (1a) and (1b), R¹ represents a hydrogen atom, an alkyl group, an alkoxy group, a cyano group, a carbonyl group, an aromatic group, or a heterocyclic group; and R² represents, a hydrogen atom, an alkyl group, an alkoxy group, a cyano group, a nitro group, a carbonyl group, an aromatic group, or a heterocyclic group.

R³ represents, a hydrogen atom, an alkyl group, or an alkoxy group. Among these, R³ is preferably a hydrogen atom, or an alkyl group having 1 to 20 carbon atoms.

R⁴ and R⁵ independently represent a hydrogen atom, an alkyl group, or an aromatic group. Among these, at least one of R⁴ and R⁵ preferably represents an alkyl group, more preferably an alkyl group having 6 to 30 carbon atoms (preferably 6 to 20 carbon atoms). Further, preferably both of R⁴ and R⁵ represent an alkyl group having 6 to 30 carbon atoms (preferably 6 to 20 carbon atoms).

R⁷ represents a hydrogen atom, an alkyl group, an alkoxy group, a cyano group, a carbonyl group, or an aromatic group. Among these, R⁷ is preferably a hydrogen atom or an alkyl group having 6 to 20 carbon atoms.

In Formulae (1a) and (1b), it is preferable from a viewpoint of further superior solubility in the ether-based nonpolar solvent, that, in the structures of Formulae (1a) and (1b), R¹ is an alkyl group or an aryl group; R² is an alkyl group or a cyano group; R³ (in the case of Formula (1a)); hereinafter the same shall apply) is a hydrogen atom, or an alkyl group having 6 to 20 carbon atoms; R⁴, R⁵ are a hydrogen atom or an alkyl group; and R⁷ (in the case of Formula (1b); hereinafter the same shall apply) is a hydrogen atom, or an alkyl group having 6 to 20 carbon atoms. Further, it is preferable that, in the structures of Formulae (1a) and (1b), R¹ is an alkyl group having 6 to 20 carbon atoms; R² is a cyano group; R³ is a hydrogen atom or an alkyl group having 6 to 20 carbon atoms; R⁴ and R⁵ are an alkyl group having 6 to 30 carbon atoms (preferably 6 to 20 carbon atoms); and R⁷ is a hydrogen atom or an alkyl group having 6 to 20 carbon atoms.

Further, the azo dye may be a compound having an optically active carbon atom from viewpoints of improving the solubility of a coloring matter in an ether-based nonpolar solvent and reducing the viscosity. Among these, there are preferably plural optically active sites (optically active points) in the molecule. When there are 3 or more optically active sites (optically active points) in the molecule, the solubility in an ether-based nonpolar solvent can be more effectively improved. Examples of substituents having an optically active point in the coloring matter include a branched-chain alkyl group with 6 to 30 carbon atoms having an optically active point, and a an alicyclic alkyl group with 6 to 30 carbon atoms having an optically active point.

Whether there is an optically active point in a molecule can be known by analyzing the chemical structure of a molecule to examine whether all of 4 substituent groups on the same carbon atom are groups different from each other in terms of a chemical structure. When a stereoisomer is in a form of a mixture, it can be detected easily by preparing a solution of a subject coloring matter compound having an optically active point, measuring the optical rotation of the solution, and deciding it as a mixture if the optical rotation is not exhibited (optical rotation is 0°).

Specific examples of azo dyes are shown below, provided that the invention is not limited to the specific examples. In this regard, Me stands for methyl, Et for ethyl, Bu for butyl, and Ph for phenyl respectively.

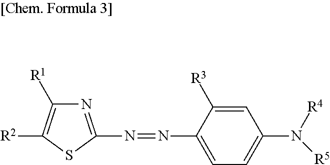

| | | | | | | Optically |
|---|---|---|---|---|---|---|
| No. | R¹ | R² | R³ | R⁴ | R⁵ | active point |
| D-1 | t-Bu | CN | H | n-C₈H₁₇ | n-C₈H₁₇ | 0 |
| D-2 | Me | CN | Me | n-C₈H₁₇ | n-C₈H₁₇ | 0 |
| D-3 | CH₂CHEtC₄H₉ | CN | MeO | CH₂CHEtC₄H₉ | CH₂CHEtC₄H₉ | 2 |
| D-4 | Ph | NO₂ | Et | n-C₁₀H₂₁ | n-C₁₀H₂₁ | 0 |
| D-5 | n-C₈H₁₇ | Me | Me | Et | Et | 0 |

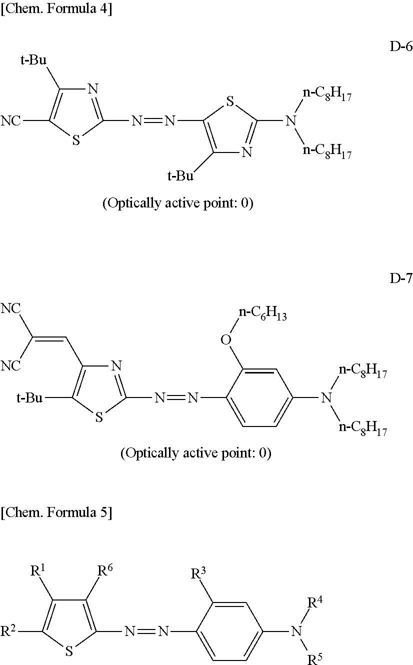

| | | | | | | Optically |
|---|---|---|---|---|---|---|
| | | | | | | active |
| No. | R¹ | R⁶ | R³ | R⁴ | R⁵ | point |
| D-8 | Me | CN | H | n-C₈H₁₇ | n-C₈H₁₇ | 0 |
| D-9 | t-Bu | CN | Me | n-C₈H₁₇ | n-C₈H₁₇ | 0 |
| D-10 | i-Pr | CO₂CH₂CHEtC₄H₉ | MeO | CH₂CHEtC₄H₉ | CH₂CHEtC₄H₉ | 2 |
| D-11 | n-C₈H₁₇ | NO₂ | H | Et | Et | 0 |

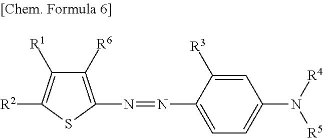

| | | | | | | | Optically |
|---|---|---|---|---|---|---|---|
| | | | | | | | active |
| No. | R² | R¹ | R⁶ | R³ | R⁴ | R⁵ | point |
| D-12 | CO₂C₆H₁₃ | Me | CO₂C₆H₁₃ | NHCOC₆H₁₃ | n-C₈H₁₇ | n-C₈H₁₇ | 0 |
| D-13 | Me | Me | CN | Me | n-C₈H₁₇ | n-C₈H₁₇ | 0 |
| D-14 | Bu | CH₂CO₂Et | CO₂Et | MeO | n-C₁₀H₂₁ | n-C₁₀H₂₁ | 0 |
| D-15 | n-C₈H₁₇ | Me | CO₂Et | C₆H₁₃O | Et | Et | 0 |

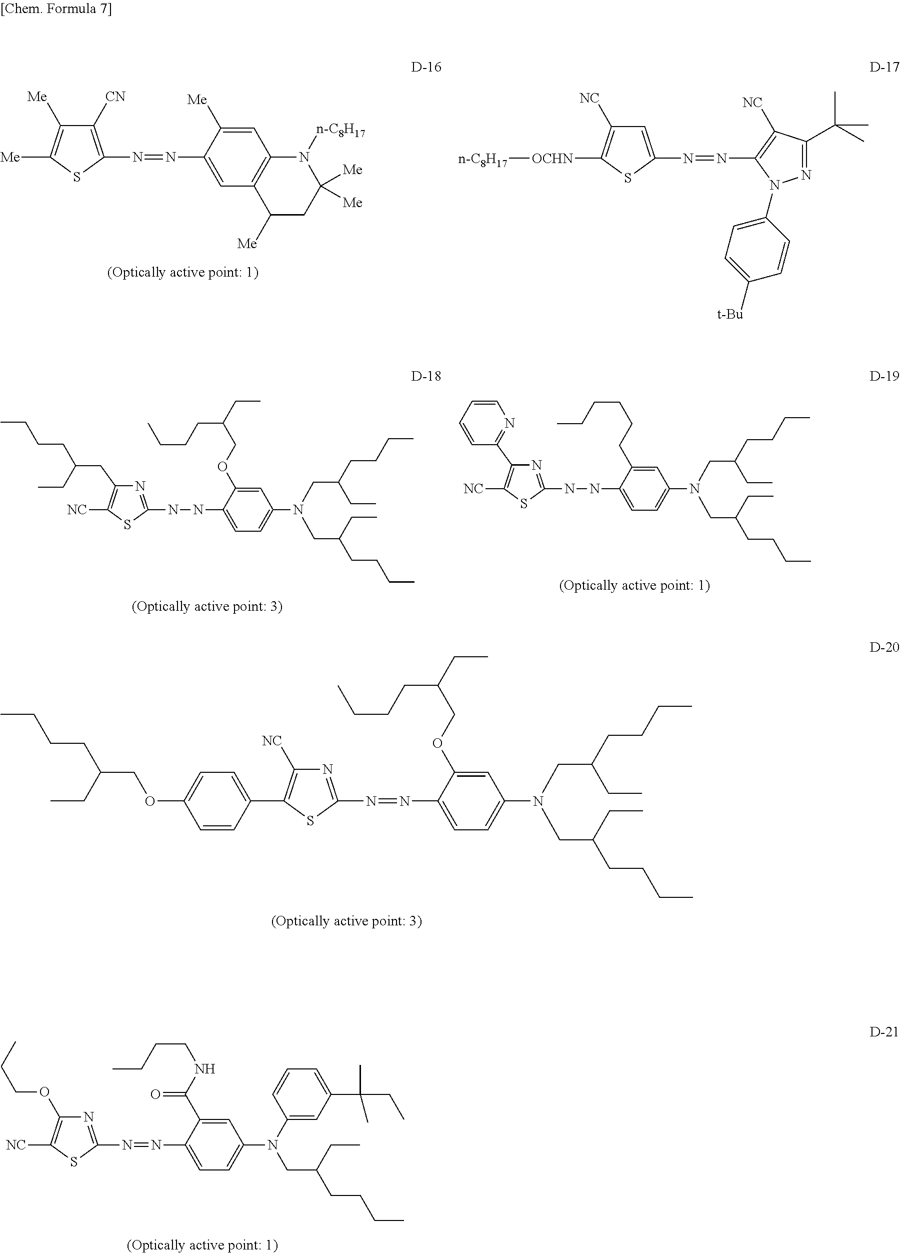

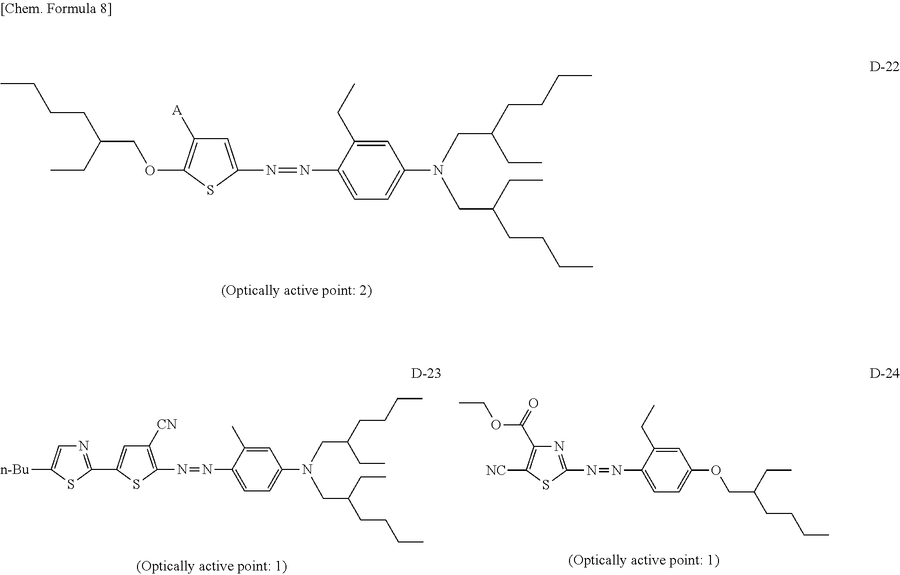

Examples of preferable azo dyes include those expressed by the following Formula (2).

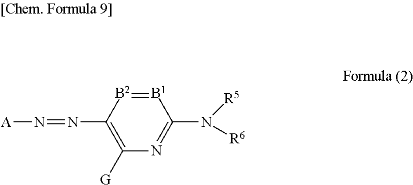

In Formula (2), A represents a residue of a 5-membered heterocyclic diazo component A-NH₂; B¹ and B² independently represent —CR¹=, —CR²=, or a nitrogen atom; B¹ and B² do not represent simultaneously nitrogen atoms; R⁵ and R⁶ independently represent a hydrogen atom, an aliphatic group, an aromatic group, a heterocyclic group, an acyl group, an alkoxycarbonyl group, an aryloxycarbonyl group, a carbamoyl group, an alkylsulfonyl group, an arylsulfonyl group, or a sulfamoyl group. G, R¹, and R² independently represent a hydrogen atom, a halogen atom, an aliphatic group, an aromatic group, a heterocyclic group, a cyano group, a carboxyl group, a carbamoyl group, an alkoxycarbonyl group, an aryloxycarbonyl group, an acyl group, a hydroxy group, an alkoxy group, an aryloxy group, a silyloxy group, an acyloxy group, a carbamoyloxy group, a heterocyclic oxy group, an alkoxycarbonyloxy group, an aryloxycarbonyloxy group, a substituted amino group substituted with an alkyl group, an aryl group or a heterocyclic group, an acylamino group, a ureide group, a sulfamoylamino group, an alkoxycarbonylamino group, an aryloxycarbonylamino group, an alkylsulfonylamino group, an arylsulfonylamino group, an aryloxycarbonylamino group, a nitro group, an alkylthio group, an arylthio group, an alkysulfonyl group, an arylsulfonyl group, an alkylsulfinyl group, an arylsulfinyl group, a sulfamoyl group, a sulfo group, or a heterocyclic thio group; and R¹ and R⁵ and/or R⁵ and R⁶ may together form a 5-membered or 6-membered ring.

With respect to an azo dye expressed by Formula (2), the description in Paragraphs from 0033 to 0071 in JP-A No. 2006-126649 may be referred to.

An azo dye may be synthesized by a method described in Hosoda Yutaka, “Shin Senryou Kagaku (New Dye Chemistry)”, Dec. 21, 1973, Gihodo Shuppan Co., Ltd.; A. V. Ivashchenko, “Dichroic Dyes for Liquid Crystal Displays”, CRC Press, 1994; Bulletin of the Chemical Society of Japan, vol. 76, p. 607-612, 2003; or Bulletin of the Chemical Society of Japan, vol. 72, p. 127-132, 1999.

### 2. Azomethine Dye

Examples of preferable azomethine dyes include those expressed by the following General Formula (3).

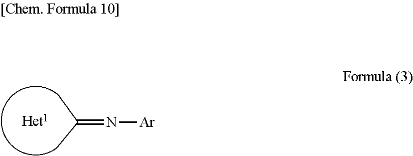

In Formula (3), Het¹ represents a ring, which does not have a dissociable group; and Ar represents an aromatic ring or a saturated heterocycle, which do not have a dissociable group. Among these, the azomethine dye preferably has at least one straight-chain or branched-chain alkyl group (preferably straight-chain alkyl group) having a relatively large carbon number such as 6 to 30 in the dye molecule from a viewpoint of high solubility in an ether-based nonpolar solvent (solubility of 1% by mass or more in dihexyl ether at 25° C. and 0.1 MPa) enabling formation of an oil composition with a high dye concentration.

The azomethine dye expressed by Formula (3) will be described in detail below.

The azomethine dye expressed by Formula (3) is preferably a dye, which does not have a dissociable group (not including a NH group), such as —SO₃H, —PO₃H₂, —CO₂H, and —OH, in the molecule. Thereby, the solubility in an ether-based nonpolar solvent can be improved.

From a viewpoint of further improved solubility in an ether-based nonpolar solvent, the azomethine dye preferably has a straight-chain or branched-chain alkyl group having 6 to 30 carbon atoms in the molecule.

When the azomethine dye has a straight-chain or branched-chain alkyl group in the molecule, from a similar reason as above, the alkyl group is preferably a straight-chain or branched-chain alkyl group having 6 to 20 carbon atoms, and the carbon number is more preferably from 6 to 10.

Examples of the ring expressed by Het¹ in Formula (3) include a 5-membered or 6-membered hydrocarbon ring, and a 5-membered or 6-membered heterocyclic ring. Examples of the ring include a benzene ring, a pyrazole ring, an isoxazole ring, a pyrazolotriazole ring, a pyrrolotriazole ring, a naphthalene ring, a pyridone ring, and a barbituric ring.

The ring expressed by Het¹ may be substituted or not substituted. A substituent, in the case in which Het¹ is substituted, may be selected appropriately from substituents except dissociable groups. Specific examples of the substituent include an alkyl group, an alkoxy group, an aryl group, —COOR¹¹, and —CONR¹¹R¹² (R¹¹ and R¹² independently represent a hydrogen atom, an alkyl group, or an aryl group, and R¹¹ and R¹² may together form a 5-membered ring, a 6-membered ring, or a 7-membered ring).

The alkyl group, alkoxy group, and aryl group for the substituent have the same definitions as the alkyl group, alkoxy group, and aryl group for R¹ in the following General Formula (3-2) respectively, and preferable examples of the alkyl group, alkoxy group, and aryl group for the substituent are also the same as the alkyl group, alkoxy group, and aryl group for R¹ in the following General Formula (3-2) respectively.

As the aromatic ring, and the saturated heterocyclic ring represented by Ar, a 5-membered or a 6-membered ring is preferable. Preferable examples of the aromatic ring or the saturated heterocyclic ring include an aromatic ring, such as a benzene ring, a naphthalene ring, a pyrrole ring, an indole ring, a pyridine ring, a quinoline ring, a pyrazine ring, a quinoxaline ring, a thiazole ring, a thiazoline ring, an oxazole ring, an oxazoline ring, and an imidazole ring; and a saturated heterocyclic ring, such as a pyrrolidine ring, tetrahydrofuran, tetrahydrofuran, tetrahydrothiophene, thiazoline, oxazoline, and imidazoline.

Among them, as Ar a benzene ring, a pyrrole ring, and an indole ring are more preferable.

The aromatic ring and the saturated heterocyclic ring represented by Ar may be substituted or not substituted. A substituent, in the case in which Ar is substituted, may be selected appropriately from substituents except dissociable groups. Specific examples of the substituent include an alkyl group, an alkoxy group, an aryl group and a halogen atom. The alkyl group, alkoxy group, and aryl group have the same definitions as the alkyl group, alkoxy group and aryl group for R¹ in the following General Formula (3-2) respectively, and preferable examples of the alkyl group, alkoxy group and aryl group for the substituent are also the same as the alkyl group, alkoxy group and aryl group for R¹ in the following General Formula (3-2) respectively.

Among the azomethine dyes represented by Formula (3), an azomethine dye expressed by the following Formula (3-2) is preferable.

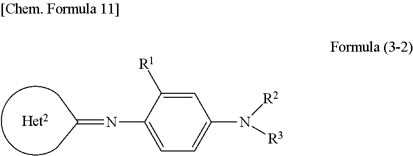

In Formula (3-2), Het² represents a coupler parent ring structure not having a dissociable group. The coupler parent ring structure represented by Het² is a molecular structure (chromophore (parent structure)) necessary for the dye to develop a color. In other words, a coupler parent ring structure is a moiety structure constituted with consecutive unsaturated bonds in a compound (a moiety structure necessary for forming a conjugated system), and for example a moiety where an aromatic, >C═C<, >C═O, >C═N═ or >N═N< are linked. Specific examples of a coupler parent ring structure include an isoxazolone skeleton, a pyrazolone skeleton, a pyrazolotriazole skeleton, a pyrrolotriazole skeleton, a benzoquinone skeleton, a naphthoquinone skeleton, a pyridone skeleton, a barbituric skeleton, a pyrimidine skeleton, a thiobarbituric skeleton, and an anilide skeleton.

Specifically, as a coupler parent ring structure, a molecular skeleton containing a 5-membered or 6-membered hydrocarbon ring, or a 5-membered or 6-membered heterocyclic ring is preferable. Examples of the hydrocarbon ring or the heterocyclic ring include a benzene ring, a pyrazole ring, an isoxazole ring, a pyrazolotriazole ring, a pyrrolotriazole ring, a naphthalene ring, a pyridone ring, a barbituric ring, a thiobarbituric ring, and a pyrimidine ring. Among them, examples of a favorable coupler parent ring structure include a benzene ring, a pyrazole ring, an isoxazole ring, a pyrazolotriazole ring, a pyrrolotriazole ring, and a naphthalene ring.

In Formula (3-2), R¹ represents a hydrogen atom, an alkyl group, an alkoxy group, or an aryl group. Groups represented by R¹ do not include a dissociable group.

In Formula (3-2), an alkyl group represented by R¹ may be unsubstituted, or have a substituent, and a alkyl group having 1 to 20 carbon atoms is preferable. Favorable examples of alkyl groups include a methyl group, an ethyl group, a n-butyl group, a tert-butyl group, a 1-methylcyclopropyl group, a 3-heptyl group, a 2-ethylhexyl group, a 2-methylhexyl group, a n-nonyl group, a n-undecyl group, a chloromethyl group, a trifluoromethyl group, an ethoxycarbonylmethyl group and a perfluoroalkyl group (for example, a perfluoromethyl group). Among them, more preferable is an alkyl group having 1 to 15 carbon atoms (further preferably 1 to 10 carbon atoms), and examples of the especially preferable alkyl group include a methyl group, an ethyl group, a tert-butyl group, a hexyl group, and a 2-ethylhexyl group.

In Formula (3-2), an alkoxy group represented by R¹ may be unsubstituted, or have a substituent, and an alkoxy group having 1 to 20 carbon atoms is preferable. Favorable examples of the alkoxy group include a methoxy group, an ethoxy group, a n-butoxy group, a tert-butoxy group, a 3-heptyloxy group, a n-hexyloxy group, a 2-ethylhexyloxy group, a n-nonyloxy group, a n-undecyloxy group, a chloromethyloxy group, a trifluoromethoxy group, an ethoxycarbonylmethoxy group, and a perfluoroalkyloxy group (for example, a perfluoromethoxy group). Among them, more preferable is an alkoxy group having 1 to 15 carbon atoms (further preferably 1 to 10 carbon atoms), and examples of especially preferable alkoxy groups include a methoxy group, an ethoxy group, a hexyloxy group, and a 2-ethylhexyloxy group.

In Formula (3-2), an aryl group represented by R¹ may be unsubstituted, or have a substituent, and an aryl group having 6 to 20 carbon atoms is preferable. Favorable examples of the aryl group include a phenyl group, a 4-methoxyphenyl group, a hexyloxyphenyl group, an octyloxyphenyl group, a 2,6-dimethylphenyl group, a 4-(dibutylamino)phenyl group, a 4-[(2-ethylhexanoyl)amino]phenyl group, and a 4-hexylphenyl group. Among them, more preferable is an aryl group having 6 to 16 carbon atoms (further preferably 6 to 12 carbon atoms), and a phenyl group is especially preferable.

In Formula (3-2), R² and R³ independently represent an alkyl group or an aryl group. Groups represented by R² or R³ do not include a dissociable group.

In Formula (3-2), the alkyl group expressed by R² or R³ may be unsubstituted or have a substituent, and an alkyl group having 1 to 30 carbon atoms is preferable. Favorable examples of the alkyl group include a methyl group, an ethyl group, a n-butyl group, a tert-butyl group, a 1-methylcyclopropyl group, a 3-heptyl group, a 2-ethylhexyl group, a 2-methylhexyl group, a n-nonyl group, a n-undecyl group, a chloromethyl group, a trifluoromethyl group, an ethoxycarbonylmethyl group, and a perfluoroalkyl group (for example, a perfluoromethyl group). Among them, an alkyl group having 6 to 30 carbon atoms is more preferable, further preferable is an alkyl group having 6 to 20 carbon atoms, and especially preferable are a hexyl group, an octyl group, a 2-ethylhexyl group, a 2-methyl hexyl group or the like.

In Formula (3-2), an aryl group represented by R² or R³ may be unsubstituted, or have a substituent, and an aryl group having 6 to 16 carbon atoms is preferable. Favorable examples of the aryl group include a phenyl group, a 4-methoxyphenyl group, a 4-tert-butylphenyl group, a 4-(dibutylamino)phenyl group, a 4-[(2-ethylhexanoyl)amino]phenyl group, and a 4-hexylphenyl group. Among them, more preferable is an aryl group having 6 to 16 carbon atoms, and a phenyl group is especially preferable.

In a case in which a group represented by any of R¹ to R³ in Formula (3-2) has a substituent, examples of the substituent include a halogen atom, an alkyl group, an aryl group, an alkoxy group, and an aryloxy group.

In Formula (3-2), at least one of groups of Het² and R¹ to R³ in a molecule has preferably a straight-chain or branched-chain alkyl group having a relatively large carbon number such as 6 to 30 carbon atoms. Thereby, the azomethine dye can exhibit favorable solubility in an ether-based nonpolar solvent.

From this viewpoint, among structures of Formula (3-2), a structure in which R¹ is a hydrogen atom, a methyl group or a methoxy group, and either or both of R² and R³ are a straight-chain or branched-chain alkyl group having 6 to 20 carbon atoms (further preferably 6 to 12 carbon atoms), is especially preferable.

Specific examples of the azomethine dye are shown below, provided that the invention is not limited to the specific examples. In this regard, Me stands for methyl, Et for ethyl, Bu for butyl, and Ph for phenyl respectively.

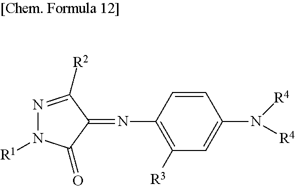

| No. | R¹ | R² | R³ | R⁴ | R⁵ |
|---|---|---|---|---|---|
| E-1 | Ph | Me | Me | n-C₈H₁₇ | n-C₈H₁₇ |
| E-2 | i-Pr | t-Bu | Me | n-C₈H₁₇ | n-C₈H₁₇ |
| E-3 | C₆H₁₃ | EtO | MeO | CH₂CHEtC₄H₉ | CH₂CHEtC₄H₉ |
| E-4 | Ph | i-Pr | Et | n-C₁₀H₂₁ | n-C₁₀H₂₁ |
| E-5 | n-C₈H₁₇ | t-Bu | Me | Et | Et |

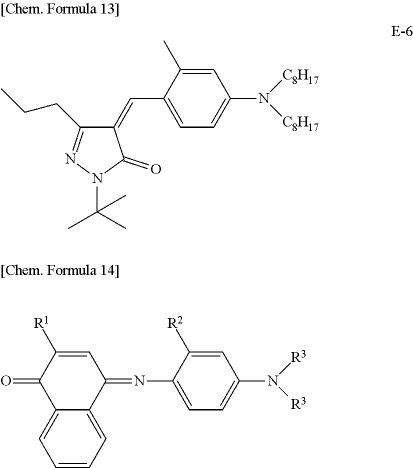

| No. | R¹ | R² | R³ |
|---|---|---|---|
| E-7 | H | H | n-C₈H₁₇ |
| E-8 | Et | H | CH₂CHEtC₄H₉ |
| E-9 | CONHC₁₆H₃₃ | Et | Et |
| E-10 | CONHC₁₆H₃₃ | H | n-Bu |

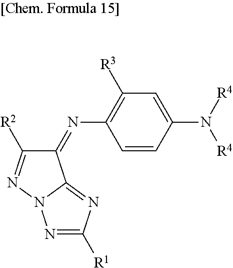

| No. | R¹ | R² | R³ | R⁴ |
|---|---|---|---|---|
| E-11 | i-Pr | t-Bu | H | n-C₈H₁₇ |
| E-12 | t-Bu | i-Pr | Me | CH₂CHEtC₄H₉ |

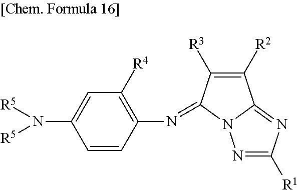

| No. | R¹ | R² | R³ | R⁴ | R⁵ |
|---|---|---|---|---|---|
| E-13 | 4-t-Bu—Ph | EST1 | CN | Me | n-C₈H₁₇ |
| E-14 | t-Bu | t-Bu | Me | H | CH₂CHEtC₄H₉ |
| E-15 | n-C₈H₁₇ | Me | CN | Et | n-C₈H₁₇ |
| E-16 | t-Bu | EST1 | MeO | H | n-C₁₀H₂₁ |

EST1 above stands for the following structure.

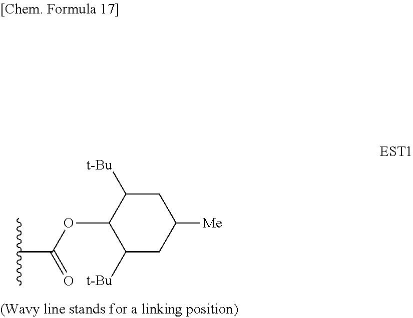 [SMILES: *C(=O)OC1C(C(C)(C)C)CC(C)CC1C(C)(C)C]

An azomethine dye according to the invention can be synthesized according to the method described in J. Am. Chem. Soc., 1957, vol. 79, p. 583; JP-A No. H9-100417; JP-A No. 2011-116898; JP-A No. 2011-12231; JP-A No. 2010-260941; and JP-A No. 2007-262165.

### 3. Methine Dye

Examples of preferable methine dyes include those represented by the following Formula (4).

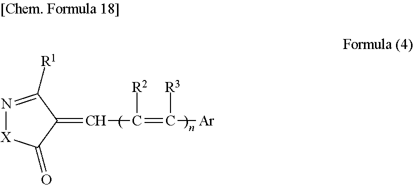

In Formula (4), R¹ represents a hydrogen atom, an alkyl group, a aryl group, —COOR¹¹ or —CONR¹¹R¹²; Ar represents an aromatic ring; R² and R³ independently represent a hydrogen atom or an alkyl group; R¹¹ and R¹² independently represent a hydrogen atom, an alkyl group or an aryl group. R¹¹ and R¹² may together form a 5-membered ring, a 6-membered ring or a 7-membered ring. n represents an integer of from 0 to 2. R¹, R², R³ and Ar do not have a dissociable group. X is an oxygen atom or N—R¹³, wherein R¹³ independently represent a hydrogen atom, an alkyl group or an aryl group.

Specific examples of the azomethine dye are shown below, but the dye is not limited to the specific examples in the invention. In this regard, Me stands for a methyl group, Et for ethyl, Pr for propyl, Bu for butyl and Ph for phenyl respectively.

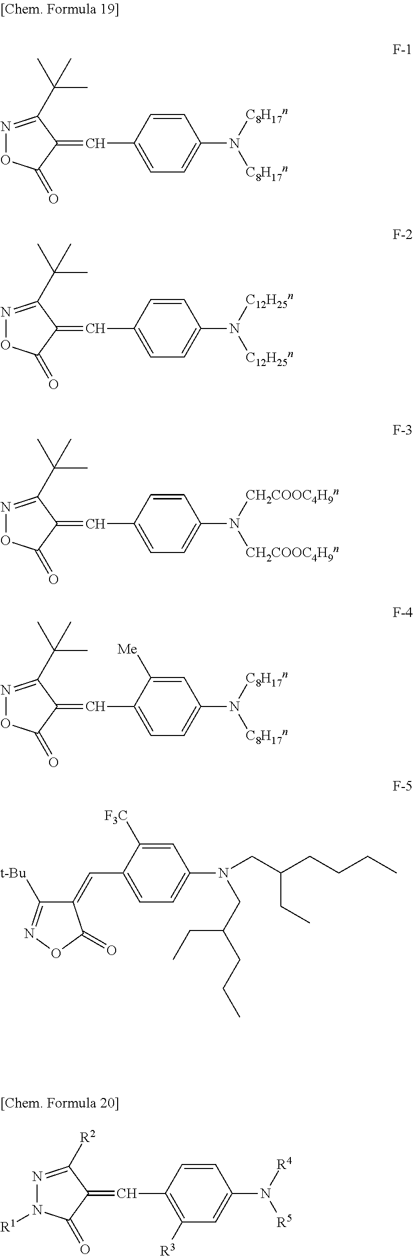

| No. | R¹ | R² | R³ | R⁴ | R⁵ |
|---|---|---|---|---|---|
| F-6 | Me | Me | H | n-C₈H₁₇ | n-C₈H₁₇ |
| F-7 | i-Pr | t-Bu | Me | n-C₈H₁₇ | n-C₈H₁₇ |
| F-8 | C₆H₁₃ | EtO | MeO | n-C₈H₁₇ | n-C₈H₁₇ |
| F-9 | Ph | i-Pr | Et | n-C₁₀H₂₁ | n-C₁₀H₂₁ |
| F-10 | n-C₈H₁₇ | Me | ET1 | Et | Et |

ET1 above stands for the following structure.

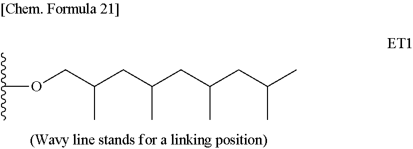 [SMILES: *OCC(C)CC(C)CC(C)CC(C)C]

The compounds can be produced by a publicly known method as disclosed in Japanese Patent No. 2707371 as well as JP-A No. H5-45789; JP-A No. 2009-263517; JP-A No. H3-72340, etc.

### 4. Phthalocyanine Dye

As a phthalocyanine dye, that having an alkyl group with 6 or more carbon atoms is preferable.

Specific examples of phthalocyanine dyes include those described in Applied Physics Express, vol. 4, p. 21604, 2011; Molecular Crystal Liquid Crystal, vol. 183, p. 411, 1990; and Molecular Crystal Liquid Crystal, vol. 260, p. 255, 1995, as well as a pigment represented by General Formula (C1) in JP-A No. 2006-133508, which may be used appropriately.

### 5. Anthraquinone Dye

Examples of preferable anthraquinone dyes include those represented by the following Formula (5).

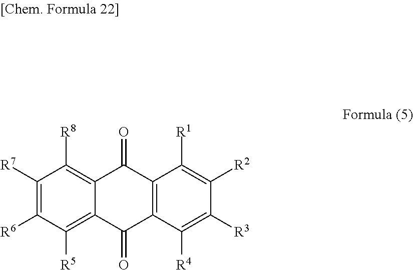

In Formula (5), R¹, R⁴, R⁵ and R⁸ independently represent a hydrogen atom, NR¹¹R¹², an alkylthio group, an arylthio group, an alkoxy group or an aryloxy group; R², R³, R⁶ and R⁷ independently represent a hydrogen atom, an alkyl group, or an alkoxy carbonyl group; and R¹¹ and R¹² independently represent a hydrogen atom, an alkyl group, an aryl group or a heterocyclic ring group, provided that R¹¹ and R¹² are not simultaneously hydrogen atoms. With respect to Formula (5), an embodiment having an alkyl group with 4 or more carbon atoms is preferable. Specific examples thereof include those described in WO 2008/142086.

The anthraquinone dyes can be synthesized according to the method described in Hosoda Yutaka, “Shin Senryou Kagaku (New Dye Chemistry)”, Dec. 21, 1973, Gihodo Shuppan Co., Ltd.; and A. V. Ivashchenko, “Dichroic Dyes for Liquid Crystal Displays”, CRC Press, 1994.

### 6. Porphyrin Dye

Examples of preferable porphyrin dyes include those represented by the following Formula (6).

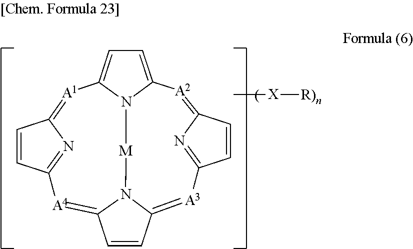

In Formula (6), A¹ to A⁴ independently represent a nitrogen atom (—N═) or —C(R¹)=; M represents a metal atom, a metal oxide, a metal hydroxide, a metal halide or 2 hydrogen atoms; —X—R represents a monovalent group to be a substituent of the pyrrole ring; wherein R represents an alkyl group having 4 to 30 carbon atoms, X represents a single bond, an oxygen atom, a sulfur atom or —N(R²)—; and n represents an integer of from 1 to 8. R¹ represents a hydrogen atom, an alkyl group, an aryl group or —X¹¹—R¹¹; R² represents a hydrogen atom, an alkyl group, or an aryl group, wherein R¹¹ represents a C4 to C30 alkyl group; Xⁱⁱ represents a single bond, an oxygen atom, a sulfur atom, or —N(R¹²)—; and R¹² represents a hydrogen atom, an alkyl group or an aryl group.

As an alkyl group represented by R¹, an alkyl group having 1 to 20 carbon atoms (more preferably 1 to 15 carbon atoms) is preferable. The alkyl group may be a straight-chain alkyl group, a branched-chain alkyl group or a cyclic alkyl group. Further, the alkyl group may be, if necessary, substituted with a substituent described below.

As an aryl group expressed by R¹, an aryl group having 6 to 20 carbon atoms (more preferably 6 to 15 carbon atoms) is preferable, and a phenyl group or a naphthyl group are more preferable. The aryl group may be, if necessary, substituted with a substituent described below.

X¹¹ and R¹¹ in a case in which R¹ represents —X¹¹—R¹¹ will be described below.

Among porphyrin dyes, a dye in which A¹ to A⁴ represent a nitrogen atom (—N═) is suitable as a dye exhibiting a hue of from violet to cyan, and a dye in which A¹ to A⁴ represent —C(R¹)═ is suitable as a dye exhibiting a hue of yellow.

A¹ to A⁴ are preferably nitrogen atoms from a viewpoint of effectiveness of advantageous effects of the invention.

Examples of metal atoms represented by M include Zn, Mg, Si, Sn, Rh, Pt, Pd, Mo, Mn, Pb, Cu, Ni, Co and Fe.

Examples of metal oxides represented by M include VO and TiO.

Examples of metal hydroxides represented by M include Si(OH)₂.

Examples of metal halides represented by M include AlCl, InCl, FeCl, TiCl₂, SnCl₂, SiCl₂ and GeCl₂.

As M, from viewpoints of hue and molar absorption coefficient, a metal atom, a metal halide or 2 hydrogen atoms are preferable; Mg, Cu, Zn, AlCl or 2 hydrogen atoms are more preferable; and Mg or 2 hydrogen atoms are especially preferable.

In Formula (6), —X—R represents a monovalent group to be substituted on 4 pyrrole rings included in Formula (6). In the porphyrin dye represented by Formula (6), there are 8 sites (the 3 position and the 4 position of each pyrrole ring) where —X—R can be introduced as a substitute.

In Formula (6), n represents the number of —X—R and is an integer of from 1 to 8. From a viewpoint of higher effectiveness of advantageous effects of the invention, n is preferably an integer of from 4 to 8, more preferably an integer of from 6 to 8, and most preferably an integer of 8. When n is an integer of 2 or more, the existing 2 or more —X—R may be the same or different.

Although a “alkyl group having 4 to 30 carbon atoms” represented by R in —X—R may be any of a straight-chain alkyl group, a branched-chain alkyl group and a cyclic alkyl group, from a viewpoint of the solubility of a dye, a branched-chain alkyl group is preferable. In a case in which the carbon number of an alkyl group represented by R is 4 or more, the solubility of the dye is favorable, the responsiveness is superior and a backflow phenomenon is mild. In a case in which the carbon number of an alkyl group represented by R is 30 or less, the molecule weight of a dye is not excessive, and the solubility and molar absorption coefficient of the dye can be maintained at a favorable level. Among alkyl groups, an alkyl group having 4 to 20 carbon atoms is preferable, an alkyl group having 8 to 10 carbon atoms is further preferable, and a branched-chain alkyl group having 4 to 20 carbon atoms (more preferably 8 to 10 carbon atoms) is especially preferable.

An alkyl group represented by R may be, if necessary, substituted with a substituent described below. For example, from viewpoints of improvement of responsiveness and suppression of backflow, an alkyl group expressed by R is also preferably a fluorinated alkyl group.

R² in “—N(R²)—” represented by X in —X—R represents a hydrogen atom, an alkyl group or an aryl group. An aryl group represented by R² has the same definitions as the aryl group represented by R¹, and the preferable scope is also the same. Further, an alkyl group represented by R² has the same definitions as an alkyl group represented by R¹, and the preferable scope is also the same.

Although there is no particular restriction on X, from a viewpoint of hue, a single bond, an oxygen atom or a sulfur atom is preferable, and a single bond or a sulfur atom is especially preferable.

In a case in which R¹ represents —X¹¹—R¹¹, R¹¹ represents an alkyl group having 4 to 30 carbon atoms, and X¹¹ represents a single bond, an oxygen atom, a sulfur atom or —N(R¹²)—. The R¹² represents a hydrogen atom, an alkyl group or an aryl group, and R¹¹ and R¹² independently have the same definitions as R and R², and the preferable scopes are also the same. Further, a preferable scope of X¹¹ is the same as the preferable scope of X.

A porphyrin dye expressed by Formula (6) (specific porphyrin dye) may be, if necessary, substituted with a substitute. There is no particular restriction on a substitution position of the substituent, and example of the substitution position include R, R¹ and R². Another example is a position of 4 pyrrole rings, which is not substituted with —X—R. From viewpoints of improvement of responsiveness and suppression of backflow, a porphyrin dye substituted with a fluorine atom is also preferable.

Specific examples of porphyrin dyes will be shown below, provided that the invention is not limited to the specific examples. In this regard, in the specific examples, Et stands for an ethyl group, Bu for a butyl group, Hex for a hexyl group, and Oct for an octyl group respectively. A wavy line attached to a group shown in the “R” column and “R¹¹” column indicates a bonding position. A specific example, whose “M” column shows H, corresponds to a specific example, in which M in Formula (6) is 2 hydrogen atoms.

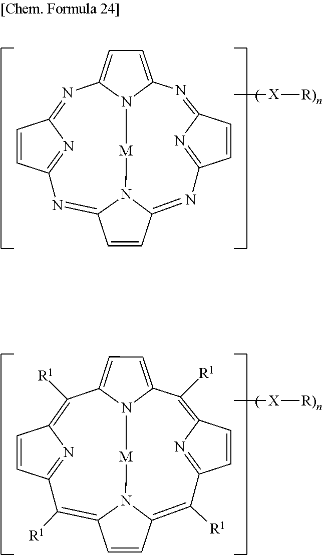

| No | X | R | n | M |
|---|---|---|---|---|
| 1 | S | 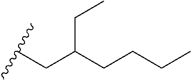 [SMILES: *CC(CC)CCCC] | 8 | H |
| 2 | S | 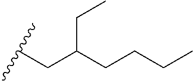 [SMILES: *CC(CC)CCCC] | 8 | Mg |
| 3 | NH | 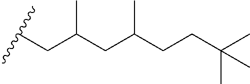 [SMILES: *CC(C)CC(C)CCC(C)(C)C] | 6 | Cu |
| 4 | O | 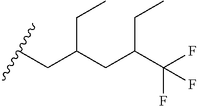 [SMILES: *CC(CC)CC(CC)C(F)(F)F] | 8 | Mg |
| 5 | — | 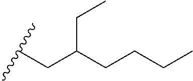 [SMILES: *CC(CC)CCCC] | 4 | H |
| 6 | NBu | 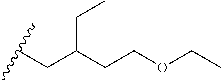 [SMILES: *CC(CC)CCOCC] | 2 | Zn |
| 7 | — | 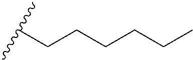 [SMILES: *CCCCCC] | 6 | H |

| No | R¹ | X | R | n | M |
|---|---|---|---|---|---|
| 8 | H | O | 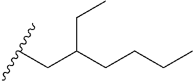 [SMILES: *CC(CC)CCCC] | 2 | Cu |
| 9 | Et | S | 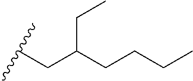 [SMILES: *CC(CC)CCCC] | 8 | H |
| 10 | Hex | NH | 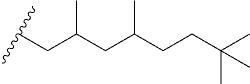 [SMILES: *CC(C)CC(C)CCC(C)(C)C] | 8 | H |
| 11 | Et | O | 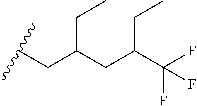 [SMILES: *CC(CC)CC(CC)C(F)(F)F] | 8 | H |
| 12 | Oct | — | 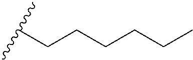 [SMILES: *CCCCCC] | 4 | H |
| 13 | H | NH | 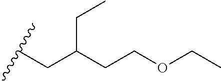 [SMILES: *CC(CC)CCOCC] | 4 | AlCl |

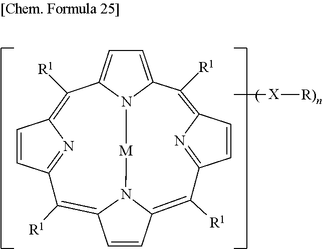

| No | R¹ | X¹¹ | R¹¹ | X | R | n | M |
|---|---|---|---|---|---|---|---|
| 14 | —X¹¹—R¹¹ | — | 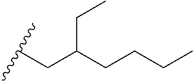 [SMILES: *CC(CC)CCCC] | — | 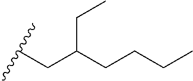 [SMILES: *CC(CC)CCCC] | 8 | H |

### <Various Additives>

The dye composition (oil) according to the invention may, if necessary, contain various additives, such as a surfactant, a UV absorber, and antioxidant, as other components. When an additive is contained, there is no particular restriction on the content, and ordinarily the content is approx. 20% by mass or less with respect to the total mass of the oil.

The dye composition may be prepared as an ink of a black color, etc. using a single dye, or prepared as an ink of a black color, etc. using a mixture of plural dyes.

When a combination of plural dyes is used, preferably a yellow dye with an absorption wave length in a range of from 400 to 500 nm, a magenta dye with an absorption wave length in a range of from 500 to 600 nm, and a cyan dye with an absorption wave length in a range of from 600 to 700 nm are mixed and used.

In this regard, “black color” means a character that among respective transmittance values at 450 nm, 500 nm, 550 nm, and 600 nm, the difference between the maximum transmittance value and the minimum transmittance value is 20% or less, and the difference is preferably 15% or less, and especially preferably 10% or less.

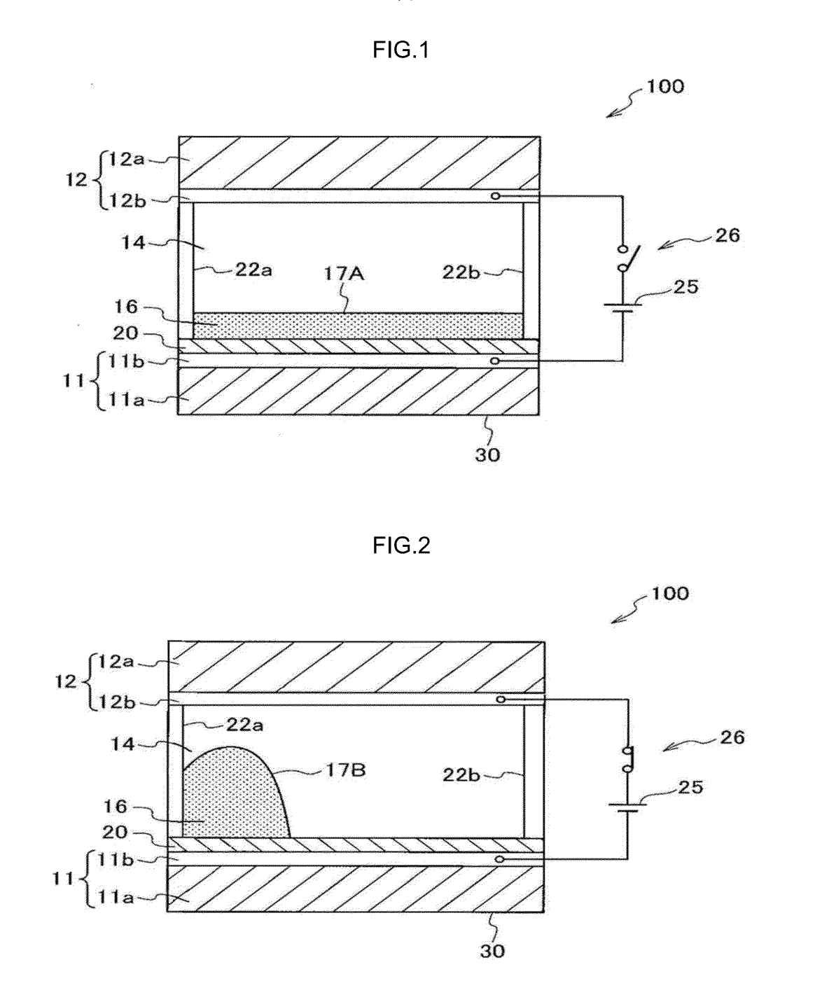

Next, an embodiment of an electrowetting display device according to the invention will be described referring to FIG. 1 and FIG. 2.

The aforedescribed dye composition for an electrowetting display according to the invention is used as a non-electroconductive oil phase to be placed between a hydrophobic insulating film and a second substrate movably on the hydrophobic insulating film, as described below. Further, the Embodiment is constituted such that a glass substrate with ITO is provided as an electrically conductive first substrate, an ether-based nonpolar solvent is used as a nonpolar solvent constituting an oil phase, and an aqueous electrolyte solution is used as a hydrophilic liquid.

FIG. 1 shows an electrowetting display device according to the embodiment in a state when the voltage is OFF.

As shown in FIG. 1, an electrowetting display device 100 according to the Embodiment is provided with an electrically conductive substrate (first substrate) 11, an electrically conductive substrate (second substrate) 12 placed opposite to the substrate 11, a hydrophobic insulating film 20 placed on the substrate 11, and a hydrophilic liquid 14 and a dye composition (oil) 16 according to the invention filled in a section of a space between the hydrophobic insulating film 20 and the substrate 12 comparted by a silicone rubber wall 22a and a silicone rubber wall 22b. The section of a space between the hydrophobic insulating film 20 and the substrate 12 comparted by the silicone rubber wall 22a and the silicone rubber wall 22b is configured as a display unit (display cell) for displaying an image by movement of the oil 16.

According to various investigations heretofore made concerning an electrowetting technology, when a dye as a colorant is added to a conventional hydrocarbon solvent such as decane as a nonpolar solvent forming an oil phase, the responsiveness in displaying an image tends to decrease, and a backflow in a voltage-applied state tends to deteriorate. The above appears significantly, when the dye concentration is increased in order to improve the display image quality.

On the other hand, when an ether-based nonpolar solvent is used as a solvent to be used in an oil phase, the oil can exist stably at both interfaces with a hydrophilic liquid and with a hydrophobic insulating film. In other words, the oil phase exists between the hydrophilic liquid and the hydrophobic insulating film as a thin film with a relatively uniform thickness. Since the oil is not repelled and forced to exist ununiformly, an image with high density and little density unevenness, superior in the responsiveness in displaying an image, and superior in a backflow characteristic in a voltage-applied state, can be obtained with an electrowetting display device according to the invention. Consequently, image display characteristics superior to a conventional electrowetting display device using a solvent such as decane other than an ether-based nonpolar solvent, are exhibited.

In the electrowetting display device 100 according to the embodiment, the substrate 11 is constituted with a substrate component 11a and a conductive film 11b having electrical conductivity formed on the substrate component 11a, such that the entire surface of the substrate exhibits electrical conductivity. The substrate 12 is placed at a position facing the substrate 11. The substrate 12 is constituted similarly as the substrate 11 with a substrate component 12a and a conductive film 12b having electrical conductivity formed on the substrate 12a, such that the entire surface of the substrate exhibits electrical conductivity. In this regard, electrical conductivity means a property that specific resistance is less than 10⁶ Ω·cm.

According to the embodiment, each of the substrate 11 and the substrate 12 are constituted with a transparent glass substrate and a transparent ITO film formed on the substrate.

The substrate component 11a and the substrate component 12a may be formed with either of a transparent material and a nontransparent material depending on the display form of a device. From a viewpoint of displaying of an image at least one of the substrate component 11a and the substrate component 12a has preferably light transmittance. Specifically, at least one of the substrate component 11a and the substrate component 12a has preferably light transmittance of 80% or higher (more preferably 90% or higher) over the entire wavelength region of from 380 nm to 770 nm.

Examples of a material to be used for the substrate component 11a and the substrate component 12a include a glass substrate (for example, an alkali-free glass substrate, a soda glass substrate, a PYREX (registered trademark) glass substrate, and a quartz glass substrate), a plastic substrate (for example, a poly(ethylene naphthalate) (PEN) substrate, a poly(ethylene terephthalate) (PET) substrate, a polycarbonate (PC) substrate, and a polyimide (PI) substrate), a metal substrate, such as an aluminum substrate, and a stainless steel substrate, and a semiconductor substrate, such as a silicon substrate. Among them, from a viewpoint of light transmittance, a glass substrate or a plastic substrate is preferable.

Further, as a substrate component, a TFT substrate provided with a thin-film transistor (TFT) may be also used. In such a case, a configuration, in which a conductive film is connected with a TFT (namely a configuration, in which a conductive film is a pixel electrode connected with a TFT), is appropriate. Thereby, a voltage can be applied individually to each pixel, so that active drive of an entire image display device becomes possible similarly as in the case of a publicly known liquid crystal display device provided with a TFT.

With respect to arrangement of a TFT, various wiring, a storage capacitor, etc. on a TFT substrate may be conducted following the publicly known arrangement, for example, the arrangement described in JP-A No. 2009-86668 may be referred to.

The conductive film 11b and the conductive film 12b may be either of a transparent film and a nontransparent film depending on the display form of a device. A conductive film means a film having electrical conductivity, and the electrical conductivity means such electrical conductivity as allowing application of a voltage, and having a character that a surface resistance is 500Ω/□ or less (preferably 70Ω/□ or less, more preferably 60Ω/□ or less, and further preferably 50Ω/□ or less).

The conductive film may be either of a nontransparent metal film such as a copper film and a transparent film, from a viewpoint of imparting light transmittance for conducting an image display, a transparent conductive film is preferable. The transparent conductive film has preferably light transmittance of 80% or higher (more preferably 90% or higher) over the entire wavelength region of from 380 nm to 770 nm. Examples of a transparent conductive film include a film containing at least one kind of indium tin oxide (ITO), indium zinc oxide (IZO), tin oxide, indium oxide, zirconium oxide, zinc oxide, cadmium oxide and magnesium oxide. Among these, from viewpoints of light transmittance and electrical conductivity, a film containing indium tin oxide (ITO) is preferable as the transparent conductive film.

The content of tin oxide in a film containing indium ITO is preferably in a range of from 5 to 15% by mass, and more preferably in a range of from 8 to 12% by mass from a viewpoint of reduction of a resistance value.

There is no particular restriction on the specific resistance of the conductive film, and it may be for example 1.0×10⁻³ Ω·cm or less

According to an example of a preferable embodiment, to the conductive film 12b of the substrate 12, an electric potential common to plural display cells constituting display pixels is impressed, meanwhile to the conductive film 11b of the substrate 11, an independent electric potential is impressed to each display pixel (display cell), so that a voltage is independently applied to each display cell (pixel). With respect to this embodiment, a publicly known liquid crystal display device can be referred to.

Although according to the embodiment, the substrate 12 is provided as an electrically conductive substrate similar to the substrate 11, the substrate 12 may be in a form without electrical conductivity, which is not provided with a conductive film, such that a voltage is applied between the conductive film 11b and the hydrophilic liquid 14. In this case, there is no particular restriction on the constitution of the substrate 12, for example, the example materials listed above for the substrate component 12a may be used.

A hydrophobic insulating film 20 is provided over the entire surface of the conductive film 11b of the substrate 11 and is in contact at least with the oil 16. When a voltage is not applied (state not displaying an image), the hydrophobic insulating film is in contact mainly with the oil, and when a voltage is applied (state displaying an image), the oil moves over the surface and an area where the oil is not any more present is in contact with an hydrophilic liquid.

Hydrophobicity means a character that when water is in contact, the contact angle is 60° or higher, and preferably a character that the contact angle is 70° or higher (more preferably 80° or higher).

The method described in “6. Sessile drop method” in JIS R3257 “Testing Method of Wettability of Glass Substrate” can be applied to measuring the contact angle. Specifically, a contact angle is determined as a contact angle θ (25° C.) of a water droplet by using a contact angle meter (CA-A, produced by Kyowa Interface Science Co., Ltd.), forming a water droplet in a size of 20 scale units, extruding the water droplet from a needle tip to contact a hydrophobic insulating film, leaving the water droplet standing for 10 sec, and then observing the shape of the water droplet through an inspection hole of the contact angle meter to obtain the contact angle θ.

“Insulating” of an insulating film means a character that the specific resistance is 10⁷ Ω·cm or higher, and preferably a character that the specific resistance is 10⁸ Ω·cm or higher (more preferably 10⁹ Ω·cm or higher).

As the hydrophobic insulating film, an insulating film exhibiting affinity for the oil 16 but low affinity for the hydrophilic liquid 14 may be used, and from a viewpoint of suppression of film degradation caused by movement of the oil by repeated voltage applications, a film having a crosslinked structure derived from a polyfunctional compound is preferable. Among them, The hydrophobic insulating film is more preferably a film having a crosslinked structure derived from a polyfunctional compound having 2 or more polymerizable groups. A crosslinked structure can be favorably formed by polymerizing at least one kind of polyfunctional compound (if necessary, together with another monomer).

In the embodiment, the film is constituted with a copolymer having copolymerized a 5-membered cyclic perfluorodiene.

The polyfunctional compound is a compound having 2 or more polymerizable groups in a molecule. Examples of polymerizable groups include a radical polymerizable group, a cationic polymerizable group and a condensation polymerizable group; and among these, a (meth)acryloyl group, an allyl group, an alkoxysilyl group, an α-fluoroacryloyl group, an epoxy group, —C(O)OCH═CH₂, etc. are preferable. In this regard, 2 or more polymerizable groups included in a polyfunctional compound may be the same or different from each other.

For forming a crosslinked structure, polyfunctional compounds may be used singly or in a combination of 2 or more kinds thereof

As the polyfunctional compound, a publicly known multifunctional polymerizable compound (a radical polymerizable compound, a cationic polymerizable compound, a condensation polymerizable compound, etc.) may be used. Examples of the polyfunctional compound include a polyfunctional acrylate, such as ethylene glycol di(meth)acrylate, di(ethylene glycol) di(meth)acrylate, poly(ethylene glycol) di(meth)acrylate, 1,6-hexanediol di(meth)acrylate, ethoxylated 1,6-hexanediol diacrylate, neopentyl glycol di(meth)acrylate, ethoxylated neopentyl glycol di(meth)acrylate, propoxylated neopentyl glycol di(meth)acrylate, tri(propylene glycol) di(meth)acrylate, polypropylene glycol) diacrylate, 1,4-butanediol di(meth)acrylate, 1,9-nonanediol diacrylate, tetra(ethylene glycol) diacrylate, 2-n-butyl-2-ethyl-1,3-propanediol diacrylate, dimethyloltricyclodecane diacrylate, neopentyl glycol hydroxypivalate diacrylate, 1,3-butylene glycol di(meth)acrylate, ethoxylated bisphenol A di(meth)acrylate, propoxylated bisphenol A di(meth)acrylate, cyclohexane dimethanol di(meth)acrylate, dimethyloldicyclopentane diacrylate, trimethylolpropane triacrylate, ethoxylated trimethylolpropane triacrylate, propoxylated trimethylolpropane triacrylate, pentaerythritol triacrylate, tetramethylolpropane triacrylate, tetramethylolmethane triacrylate, pentaerythritol tetraacrylate, caprolactone modified trimethylolpropane triacrylate, ethoxylated isocyanuric acid triacrylate, tri(2-hydroxyethyl isocyanurate)triacrylate, propoxylate glyceryl triacrylate, tetramethylolmethane tetraacrylate, pentaerythritol tetraacrylate, ditrimethylolpropane tetraacrylate, ethoxylated pentaerythritol tetraacrylate, dipentaerythritol hexaacrylate, neopentyl glycol oligoacrylate, 1,4-butanediol oligoacrylate, 1,6-hexanediol oligoacrylate, trimethylolpropane oligoacrylate, pentaerythritol oligoacrylate, urethane acrylate, epoxy acrylate, and polyester acrylate.

In addition to the above, a polyfunctional polymerizable compound may be selected appropriately from publicly known polymerizable compounds described in, for example, Paragraphs from 0031 to 0035 of JP-A No. 2008-181067, Paragraphs from 0149 to 0155 of JP-A No. 2008-139378, and Paragraphs from 0142 to 0146 of JP-A No. 2010-134137 as the polyfunctional compound.

The polyfunctional compound has preferably 3 or more polymerizable groups (preferably 4 or more, more preferably 5 or more) in a molecule. Thereby, the density of a crosslinked structure in a film can be further increased, and therefore degradation of a hydrophobic insulating film due to repeated voltage applications can be further suppressed.

As the polyfunctional compound, a fluorine-containing compound is preferable, and a polyfunctional compound with a fluorine content of 35% by mass or more (preferably 40% by mass or more, more preferably 45% by mass or more) with respect to the molecular weight is more preferable. When a polyfunctional compound contains a fluorine atom (especially at a fluorine content of 35% by mass or more with respect to the molecular weight), the hydrophobicity of a hydrophobic insulating film is further enhanced. There is no particular restriction on the upper limit of the fluorine content in a polyfunctional compound, and the upper limit may be, for example, 60% by mass (preferably 55% by mass, and more preferably 50% by mass) with respect to the molecular weight.

As a fluorine-containing compound which is a polyfunctional compound, for example, fluorine-containing compounds described in Paragraphs from 0007 to 0032 of JP-A No. 2006-28280.

A preferable polymerization method for a polyfunctional compound is a bulk polymerization or a solution polymerization.

Examples of methods of polymerization initiation include a method using a polymerization initiator (for example, a radical initiator), a method of irradiation with light or radioactive ray, a method of adding an acid, a method of adding a photoacid generator and then irradiating with light, and a method of heating for causing dehydration condensation. The polymerization methods and the polymerization initiation methods are described in, for example, Tsuruta Teiji, “Kobunshi Gosei Hoho (Polymer Synthesis Method)”, revised version (Nikkan Kogyo Shimbun, Ltd., 1971), or Otsu Takayuki, and Kinoshita Masayoshi, “Kobunshi Gosei no Jikkenho (Experimental Technique of Polymer Synthesis)”, Kagaku-Dojin Publishing Company, Inc., 1972, pp. 124-154.

A hydrophobic insulating film is prepared favorably using a curable composition containing a polyfunctional compound. A curable composition may contain 1 kind of or 2 or more kinds of polyfunctional compounds, and a curable composition may further contain a monofunctional compound. As a monofunctional compound, a publicly known monofunctional monomer can be used.

Although there is no particular restriction on the content (in the case of presence of 2 or more kinds, the content means the total content thereof; hereinafter the same shall apply) of a polyfunctional compound in a curable composition, from a viewpoint of curability, the content with respect to the total solid in a curable composition is preferably 30% by mass or more, more preferably 40% by mass or more, and especially preferably 50% by mass or more. The total solid means total components except a solvent.

A curable composition preferably further contains at least one kind of solvent. Examples of a solvent include ethyl acetate, butyl acetate, acetone, methyl ethyl ketone, methyl isobutyl ketone, cyclohexanone, tetrahydrofuran, dioxane, N,N-dimethylformamide, N,N-dimethylacetamide, benzene, toluene, acetonitrile, methylene chloride, chloroform, dichloroethane, methanol, ethanol, 1-propanol, 2-propanol, 1-butanol, propylene glycol monomethyl ether, propylene glycol monomethyl ether acetate, cyclohexanone, cyclohexanol, ethyl lactate, methyl lactate, and caprolactam.

The content (in the case of presence of 2 or more kinds, the content means the total content thereof) of the solvent in a curable composition with respect to the total mass of the curable composition is preferably from 20 to 90% by mass, more preferably from 30 to 80% by mass, and especially preferably from 40 to 80% by mass.

The curable composition preferably further contains at least one kind of polymerization initiator. As the polymerization initiator, a polymerization initiator that generates a radical by an action of at least one of heat and light is preferable.

Examples of a polymerization initiator that initiates a radical polymerization by an action of heat include an organic peroxide, an inorganic peroxide, an organic azo compound, and a diazo compound. Examples of an organic peroxide include benzoyl peroxide, halogenated benzoyl peroxide, lauroyl peroxide, acetyl peroxide, dibutyl peroxide, cumene hydroperoxide, and butyl hydroperoxide. Examples of an inorganic peroxide include hydrogen peroxide, ammonium persulfate, and potassium persulfate. Examples of an organic azo compound include 2-azo-bis-isobutyronitrile, 2-azo-bis-propionitrile, and 2-azo-bis-cyclohexanedinitrile. Examples of a diazo compound include diazoaminobenzene, and p-nitrobenzenediazonium.

Examples of a polymerization initiator that initiates a radical polymerization by an action of light include compounds, such as hydroxyalkylphenones, aminoalkylphenones, acetophenones, benzoins, benzophenones, phosphine oxides, sa ketals, anthraquinones, thioxanthones, azo compounds, peroxides, 2,3-dialkyldione compounds, disulfide compounds, fluoroamine compounds and an aromatic sulfoniums. Examples of the hydroxyalkylphenones include 2-hydroxy-2-methyl-1-phenyl-1-propan-1-one, 1-hydroxycyclohexyl phenyl ketone, 1-[4-(2-hydroxyethoxy)-phenyl]-2-hydroxy-2-methyl-1-propan-1-one, 2-hydroxy-1-{4-[4-(2-hydroxy-2-methyl-propionyl)-benzyl]phenyl}-2-methyl-propan-1-one, 1-hydroxydimethyl phenyl ketone and 1-hydroxycyclohexyl phenyl ketone.

Examples of the aminoalkylphenones include 2-dimethylamino-2-(4-methylbenzyl)-1-(4-morpholin-4-yl-phenyl)butan-1-one, 2-benzyl-2-dimethylamino-1-(4-morpholinophenyl)-butanone-1, and 2-methyl-1-(4-methylthiophenyl)-2-morpholinopropan-1-one.

Examples of the acetophenones include 2,2-diethoxyacetophenone and p-dimethylacetophenone.

Examples of the benzoins include benzoin benzenesulfonic acid ester, benzoin toluenesulfonic acid ester, benzoin methyl ether, benzoin ethyl ether and benzoin isopropyl ether.

Examples of the benzophenones include benzophenone, 2,4-dichlorobenzophenone, 4,4-dichlorobenzophenone and p-chlorobenzophenone.

Examples of the phosphine oxides include 2,4,6-trimethylbenzoyl diphenylphosphine oxide.

Further, a sensitizing dye may be used in combination with the polymerization initiator.

Although there is no particular restriction on the content of a polymerization initiator, the content is preferably from 0.1 to 15% by mass with respect to the total solid of a curable composition, more preferably from 0.5 to 10% by mass, and especially preferably from 2 to 5% by mass.

The curable composition may, if necessary, contain another component. Examples of such other component include inorganic oxide fine particles, a silicone-type or fluorine-type antifouling agent, a slipping agent, a polymerization inhibitor, a silane coupling agent, a surfactant, a thickener, and a leveling agent.

When such other component is included, the content thereof is preferably in a range of from 0 to 30% by mass with respect to the total solid content of the curable resin composition, more preferably in a range of from 0 to 20% by mass, and especially preferably in a range of from 0 to 10% by mass.

Although there is no particular restriction on the film thickness of the hydrophobic insulating film, it is preferably from 50 nm to 10 μm, and more preferably from 100 nm to 1 μm. When the film thickness of the hydrophobic insulating film is in the range, the balance between an insulation property and a drive voltage is preferable.

### <Formation Method of Hydrophobic Insulating Film>

A hydrophobic insulating film can be produced favorably by the following method. Namely, a method includes a step for forming a curable layer, in which a curable layer is formed by applying a curable composition containing a polyfunctional compound to a surface of a substrate 11 imparted with electrical conductivity (in the embodiment, a surface of the conductive film 11b of the substrate 11), and a curing step, in which a polyfunctional compound in the formed curable layer is polymerized to cure the curable layer. By such a method a hydrophobic insulating film with a crosslinked structure is formed.

For forming a hydrophobic insulating film 20 as a curable layer on a substrate 11, a publicly known coating method or transfer method may be used.

When a coating method is used, a curable composition is coated on a substrate 11 (preferably, then dried) to form a curable layer. As a coating method, a publicly known method, such as a spin coating process, a slit coating method, a dip coating method, an air-knife coating method, a curtain coating method, a roller coating method, a wire bar coating method, a gravure coating method or an extrusion coating method, may be used.

When a transfer method is used, a transfer material with a curable layer formed in advance using a curable composition is prepared, and then the curable layer of the transfer material is transferred on to a substrate 11 to form a curable layer on the substrate 11. The details of a transfer method may be referred to, for example, Paragraphs from 0094 to 0121 of JP-A No. 2008-202006 or Paragraphs from 0076 to 0090 of JP-A No. 2008-139378.

Curing of a curable layer (polymerization of a polyfunctional compound) can be performed, for example, by executing at least either of irradiation with an active energy ray (hereinafter also referred to as “exposure”) and heating.

Examples of an active energy ray to be used preferably for an exposure include ultraviolet light (g-line, h-line, i-line, etc.), electron beam and X-ray. The exposure may be carried out using a publicly known exposing device based on a proximity process, a mirror projection process, a stepper process, etc. The exposure dose during an exposure may be, for example, from 10 mJ/cm² to 2000 mJ/cm², and preferably from 50 mJ/cm² to 1000 mJ/cm².

By radiating light through a predetermined photomask for exposure, followed by development with a developing solution such as an alkali solution, a hydrophobic insulating film patterned in a desired pattern can be obtained.

Heating can be performed by a publicly known method, for example, using a hot plate or an oven. The heating temperature may be set appropriately, and for example it can be set at from 100° C. to 280° C., and preferably from 150° C. to 250° C. The heating time may be also set appropriately, and for example it can be set at from 2 min to 120 min, preferably from 5 min to 60 min.

In the embodiment, the hydrophilic liquid 14 and the oil 16 are filled between the hydrophobic insulating film 20 and the substrate 12.

The hydrophilic liquid 14 and the oil 16 are liquids which are not miscible each other, and present separated from each other bounded by the interface 17A or the interface 17B as shown in FIG. 1 and FIG. 2. In FIG. 1 and FIG. 2, the interface 17A depicts the interface between the hydrophilic liquid 14 and the oil 16 in a state when the voltage is OFF, and the interface 17B depicts the interface between the hydrophilic liquid 14 and the oil 16 in a state when the voltage is ON.

The oil 16 is a non-electroconductive liquid containing at least an ether-based nonpolar solvent with a relative dielectric constant of 5 or less (in this case, dihexyl ether) and a dye, and configured such that the dye content with respect to the total oil phase is 10% by mass or more (a dye composition for an electrowetting display).

The oil is colored, since it contains a dye, and when the dye content is in a range of 10% by mass or more (preferably 20% by mass or more), an image with a higher contrast ratio, and further superior in discriminability and clearness can be obtained. In the case of a conventional electrowetting display device with an oil phase of a composition containing a dye at such a concentration, the responsiveness of the oil when a voltage is applied is apt to decrease and the image display quality is apt to be impaired. Meanwhile, according to the invention, since an ether-based solvent with a relative dielectric constant of 5 or less is selectively used as a solvent constituting an oil phase, the responsiveness of the oil can be maintained favorable and a backflow in a voltage applied state can be suppressed so that an electrowetting display device superior in image display qualities can be obtained.

The relative dielectric constant of the oil is preferably small. The relative dielectric constant of the oil is preferably in a range of 10.0 or less, and more preferably in a range of from 2.0 to 10.0. When the relative dielectric constant is within the range, it is preferable because the response speed is higher and driving (operation) at a lower voltage is possible compared to a case in which the relative dielectric constant exceeds 10.0.

A relative dielectric constant is a value determined by injecting an oil in a glass cell with a 10-μm cell gap provided with an ITO transparent electrode, and measuring the electrical capacity of the obtained cell using a 2353LCR METER manufactured by NF Corporation (measurement frequency: 1 kHz) at 20° C. and 40% RH.

The viscosity of the oil is preferably 10 mPa·s or less in terms of dynamic viscosity at 20° C. Among them, the viscosity is preferably 0.01 mPa·s or more, and more preferably from 0.01 mPa·s to 8 mPa·s. When the viscosity of the oil is 10 mPa·s or less, it is preferable because the response speed is higher and driving (operation) at a lower voltage is possible compared to a case in which the viscosity exceeds 10 mPa·s. In this regard, a dynamic viscosity is a value measured by a viscometer (Model 500, produced by Toki Sangyo CO., Ltd.) conditioned to 20° C.

The oil is preferably substantially immiscible with a hydrophilic liquid described below. Specifically, the solubility (25° C.) of the oil in a hydrophilic liquid is preferably 0.1% by mass or less, more preferably 0.01% by mass or less, and especially preferably 0.001% by mass or less.

The higher the OD (image density) value of an electrowetting display device according to the invention is, the better the discriminability or clearness of an image are improved. Therefore, in the invention, the OD value at the local maximum absorption wave length of a specific pigment per thickness of an oil layer is preferably 0.5/μm or more, more preferably 0.65/μm or more, and further preferably 1.0/μm or more.

The hydrophilic liquid 14 is an electrically conductive hydrophilic liquid. Electrically conductive means a character that the specific resistance is 10⁵ Ω·cm or less (preferably 10⁴ Ω·cm or less).

A hydrophilic liquid is composed, for example, by containing an electrolyte and an aqueous solvent.

Examples of an electrolyte include a salt, such as sodium chloride, potassium chloride and tetrabutylammonium chloride. The concentration of an electrolyte in the hydrophilic liquid is preferably from 0.1 mol/L to 10 mol/L, more preferably from 0.1 mol/L to 5 mol/L.

As an aqueous solvent, water or an alcohol is appropriate, and an additional aqueous solvent other than water may be contained. Examples of an alcohol include ethanol, ethylene glycol, and glycerol.

An aqueous solvent not containing a surfactant is preferable from a viewpoint of the responsiveness.

In the electrowetting display device 100, a power source 25 (voltage application unit) for applying a voltage between the conductive film 11b and the conductive film 12b across the hydrophilic liquid 14, and a switch 26 for switching on/off the voltage are electrically connected.

In the embodiment, a voltage (electric potential) can be applied to the hydrophilic liquid 14 by applying a voltage to the conductive film 12b provided on the substrate 12. Although, as described above, in the embodiment, the substrate 12 is configured such that the surface in contact with the hydrophilic liquid 14 is electrically conductive (configuration that an ITO film is present as a conductive film on the surface of the substrate component 12a in contact with the hydrophilic liquid 14), the configuration is not limited thereto. For example, without providing the substrate 12 with the conductive film 12b, an electrode may be inserted into the hydrophilic liquid 14, and a voltage (electric potential) is applied to the hydrophilic liquid 14 via the inserted electrode.

Next, the actions of the electrowetting display device 100 (voltage off-state and voltage on-state) will be described.

As shown in FIG. 1, in a voltage off-state, the affinity between the hydrophobic insulation film 20 and the oil 16 is high, therefore the oil 16 is in a state in contact with the entire surface of the hydrophobic insulating film 20. When the switch 26 of the electrowetting display device 100 is switched on and a voltage is applied, the interface between the hydrophilic liquid 14 and the oil 16 is deformed from the interface 17A in FIG. 1 to the interface 17B shown in FIG. 2. In this course, the contact area between the hydrophobic insulating film 20 and the oil 16 decreases, and the oil 16 moves to an edge of the cell as shown in FIG. 2. This phenomenon occurs because a charge is generated at the surface of the hydrophobic insulation film 20 by the application of a voltage, and due to the charge, the hydrophilic liquid 14 pushes the oil 16 aside to come into contact with the hydrophobic insulation film 20.

When the switch 26 of the electrowetting display device 100 is switched off to a voltage off-state, the state returns to a state of FIG. 1.

In the electrowetting display device 100, the actions shown in FIG. 1 and FIG. 2 are performed repeatedly.

Although an embodiment of an electrowetting display device is described above referring to FIG. 1 and FIG. 2, the device is not limited to the embodiment.

For example, although a conductive film 11b of a substrate 11 is provided over an entire surface of a substrate component 11a in FIG. 1 and FIG. 2, a conductive film 11b may be provided on only a part of a surface of a substrate component 11a. Further, although a conductive film 12b of a substrate 12 is provided over an entire surface of a substrate component 12a, a conductive film 12b may be provided on only a part of a surface of a substrate component 12a.

Further in a embodiment, by adding a dye to the oil 16 for coloring the same in a desired color (for example, black, red, green, blue, cyan, magenta, and yellow), the oil 16 can function as a pixel responsible for image display of an electrowetting display device. In this case, the oil 16 functions, for example, also as a light shutter, which switches a pixel to and from an on-state and an off-state. In this case, the electrowetting display device may be configured as any of a transmissive type, a reflective type, and a semi-transmissive type.

Further, the electrowetting display device of the Embodiment may have a UV screening layer on the outer side (opposite to a surface facing the oil) of at least one of the first substrate and the second substrate. Thereby, the light resistance of the display device can be further improved.

As a UV cuttinglayer, those publicly known may be used, and for example, a UV cutting layer containing a UV absorber (for example, a UV screening film) may be used. Preferably a UV cutting layer absorbs 90% or higher of light with a wavelength of 380 nm.

A UV cutting layer may be provided by a publicly known method, such as a method, by which a layer is bonded on the outer surface of at least one of the first substrate and the second substrate with an adhesive.

In the electrowetting display device, a structure shown in FIG. 1 (a section of a space between the hydrophobic insulating film 20 and the substrate 12 comparted by the silicone rubber wall 22a and the silicone rubber wall 22b in a grid-like pattern (display cell)) is constructed as a pixel constituting a display unit, and a plural number of the display cells are arrayed two-dimensionally, so that image display becomes possible. In this case, the conductive film 11b may be a film patterned independently with respect to each pixel (display cell) (for example, in the case of an active matrix type image display device), or a film patterned in a form of stripes extending over plural pixels (display cells) (for example, in the case of a passive matrix type image display device).

The electrowetting display device 100 may be configured as a transmissive type display device by using an optically transparent substrate, such as a glass or a plastic (poly(ethylene terephthalate), poly(ethylene naphthalate), etc.) as the substrate component 11a and the substrate component 12a, and an optically transparent film as the conductive film 11b, 12b and the hydrophobic insulating film 20. When a reflective plate is placed outside the display cell in the pixel of this transmissive type display device, a reflective type display device may be configured.

In this regard, a pixel of a reflective type image display device can be prepared, for example, by using a film having also a function as a reflective plate for the conductive film 11b (for example, a metal film, such as an Al film and an Al alloy film), or using a film having also a function as a reflective plate for the substrate component 11a (for example, a metal film, such as an Al film and an Al alloy film).

Other configurations of the display cell and the image display device of the electrowetting display device 100 of the embodiment may be the same as publicly known configurations described in, for example, in JP-A No. 2009-86668, JP-A No. H10-39800, JP-A No. 2005-517993, JP-A No. 2004-252444, JP-A No. 2004-287008, JP-A No. 2005-506778, JP-A No. 2007-531917, and JP-A No. 2009-86668. Further, a configuration of a publicly known active matrix type-, or passive matrix type-liquid crystal display device may be also referred to.

An electrowetting display device may be configured using, in addition to the display cell (display pixel), a component similar to that for a publicly known liquid crystal display device, such as a backlight, a spacer for adjusting a cell gap, and a sealing material for sealing if necessary. In this case, an oil and a hydrophilic liquid may be placed in a section on the substrate 11 comparted by the silicone rubber walls, for example, by an ink jet method.

An example of a production method for the electrowetting display device 100 of the embodiment includes a substrate preparation step for preparing a substrate 11, a step for forming a hydrophobic insulating film 20 on a electrically conductive surface of the substrate 11, a partition wall formation step for forming a partition wall that comparts a surface provided with the hydrophobic insulating film 20 of the substrate 11, an application step for applying an oil 16 and a hydrophilic liquid 14 (for example, by an ink jet method) to a section comparted by the partition walls, a cell formation step for forming a cell (display unit) by overlaying a substrate 12 on the side applied with the oil 16 and the hydrophilic liquid 14 of the substrate 11 after the application step, and, if necessary, a sealing step for sealing the cell by bonding the substrate 11 and the substrate 12 around the cell. A sealing material ordinarily used for producing a liquid crystal display device may be used for bonding the substrate 11 and the substrate 12.

Further, after the partition wall formation step and before the cell formation step, a spacer formation step for forming a spacer for adjusting a cell gap may be provided.

### EXAMPLES

The invention will be described below more specifically by way of Examples, provided that the invention be by no means limited to the following Examples, to the extent the spirit of the invention is not surpassed. The term “part” means herein “part by mass” unless otherwise specified.

### Example 1

### 1. Preparation of Dye Composition

A dye selected from the the following dyes P-1 to P-6 was mixed with dihexyl ether (relative dielectric constant ∈ᵣ: 2.1, boiling point: 228° C., solidifying point: −43° C., produced by Tokyo Chemical Industry Co., Ltd.), dipentyl ether (relative dielectric constant ∈ᵣ: 2.1, boiling point: 188° C., solidifying point: −69° C., produced by Tokyo Chemical Industry Co., Ltd.), or n-decane (boiling point: 174.2° C., solidifying point: −29.7° C., produced by Tokyo Chemical Industry Co., Ltd.) to prepare 2.5 mL of 20% by mass colored solutions (dye compositions).

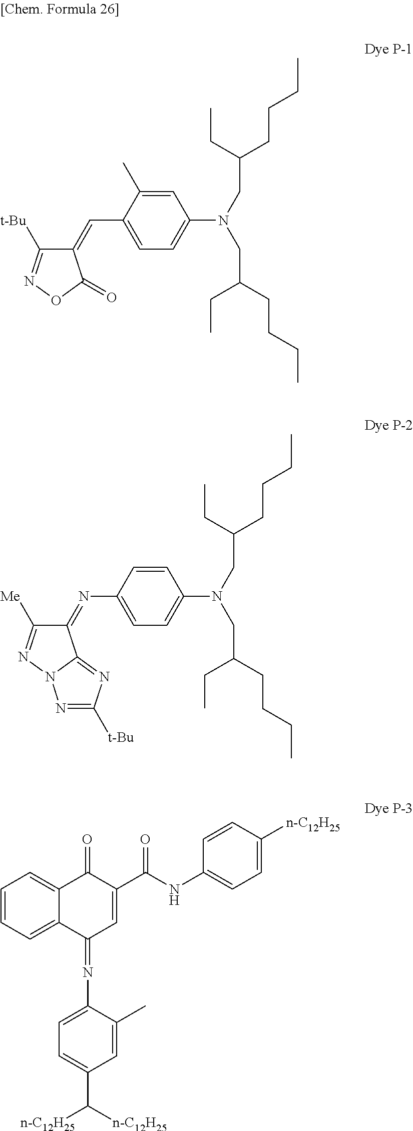

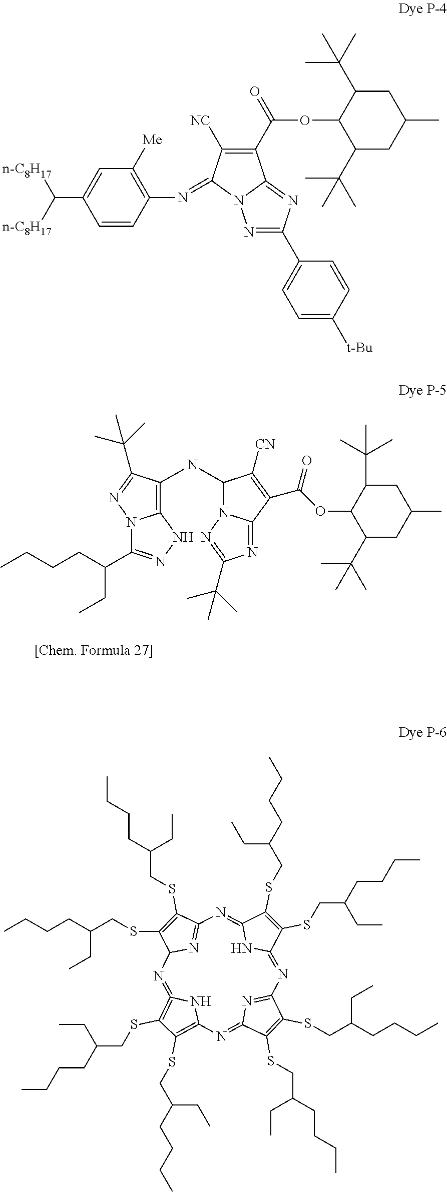

### <2. Evaluation A>

The following measurements and evaluations were conducted on the above dye compositions. The results of the measurements and evaluations are shown in the following Table 1 to Table 3.

### (1) Solubility

Each of the prepared 20% by mass solutions (dye compositions) was heated at 50° C. and then left standing at room temperature for 12 hours to obtain a supernatant liquid. The amount of the unsolved dye was weighed and the solubility of each pigment in dihexyl ether or n-decane at 25° C. and 0.1 MPa was calculated.

TABLE 1

| | Molecular | Solubility [% by mass] | |
|---|---|---|---|
| Kind | weight | Dihexyl ether | n-Decane |
| Dye P-1 | 482 | 20 or more | 20 or more |
| Dye P-2 | 506 | 20 or more | 20 or more |
| Dye P-3 | 885 | 20 or more | 20 or more |
| Dye P-4 | 859 | 20 or more | 18 |
| Dye P-5 | 713 | 20 or more | 9 |
| Dye P-6 | 1468 | 20 or more | 20 or more |

### (2) Low Temperature Suitability

Each dye composition was placed in a vial, and the vial was left standing in an ice bath (calcium chloride+ice) at −41° C. for 12 hours. The condition of each dye composition after standing was observed and evaluated according to the following evaluation criteria.

### <Evaluation Criteria>

A: A dye composition was maintained in a liquid state.

B: A dye composition was not maintained in a liquid state, and changed to a solid state.

TABLE 2

| | Low temperature suitability | | |
|---|---|---|---|
| | Dihexyl ether | Dipentyl ether | Decane |
| | (present invention) | (present invention) | (comparative) |
| Dye P-1 | A | A | B |
| Dye P-2 | A | A | B |
| Dye P-3 | A | A | B |
| Dye P-4 | A | A | B |
| Dye P-5 | A | A | B |
| Dye P-6 | A | A | B |

As shown in Table 2, in contrast to comparative dye compositions containing decane heretofore used, the dye compositions according to the invention maintained a liquid state even at a low temperature and were superior in low temperature suitability for a use in an electrowetting display.

### (2) High Temperature Suitability

Each dye composition was placed in a vial, and the vial was left standing in an oil bath without a cap at 180° C. for 2 hours. The mass of the vial after standing was weighed and evaluated according to the following evaluation criteria.

### <Evaluation Criteria>

A: Decrease in the mass of the vial was less than 10%.

B: Decrease in the mass of the vial was 10% or more.

TABLE 3

| | High temperature suitability | | |
|---|---|---|---|
| | Dihexyl ether | Dipentyl ether | Decane |
| | (present invention) | (present invention) | (comparative) |
| Dye P-1 | A | A | B |
| Dye P-2 | A | A | B |
| Dye P-3 | A | A | B |
| Dye P-4 | A | A | B |
| Dye P-5 | A | A | B |
| Dye P-6 | A | A | B |

As shown in Table 3, in contrast to comparative dye compositions containing decane heretofore used, the dye compositions according to the invention exhibited low volatility in a high temperature environment and were superior in high temperature suitability for a use in an electrowetting display.

### Example 2

### 1. Preparation of Dye Ink (Oil)

An argon gas was bubbled into dihexyl ether or dipentyl ether to obtain dihexyl ether or dipentyl ether containing dissolved oxygen at 10 ppm or less, to which each of the dyes P-1 to P-6 was added as set forth in the following Table 4 to a dye concentration of 20% by mass to prepare dye inks (oils) P1 to P7 constituting oils for an electrowetting display device.

Further, a comparative dye ink D1 was prepared as a comparative sample similarly to the dye ink P1, except that n-decane conditioned as above to dissolved oxygen of 10 ppm or less was used instead of dihexyl ether.

### <2. Production of Test Cell>

On a surface of a 100 nm-thick indium tin oxide (ITO) film provided on a glass substrate (10 mm×10 mm) as a transparent electrode, a fluorine-containing polymer (trade name: CYTOP, catalog number CTL-809M, produced by Asahi Glass Co., Ltd.) was coated to a thickness of 600 nm to form a fluoropolymer layer as a hydrophobic insulating film. Then on the fluoropolymer layer, a picture frame-shaped silicone rubber wall, which was prepared by cutting out a tetrahedron in a size of 8 mm×8 mm×50 μm from the central part of a silicone rubber in a size of 1 cm×1 cm (50 μm-thick sealing material SILIUS (trade name); produced by Fuso Rubber Go., Ltd.) was placed to form a display unit. One of the dye ink (oil) prepared as above was injected into a space surrounded by the silicone rubber wall to a thickness of 4 μm to form an oil layer. On the injected oil, ethylene glycol was injected to a thickness of 46 μm. To the top thereof, a glass substrate provided with an ITO film was further placed such that the ITO film faced to the dye ink and the aqueous electrolyte solution, and immobilized.

Thereby electrowetting test cells (electrowetting display device) having the structure shown in FIG. 1 were completed.

### <3. Evaluation B>

With respect to the test cells, the following measurements and evaluations were carried out. The results of the measurements and evaluations are shown in the following Table 4.

### (1) Density Unevenness

The density unevenness of an oil layer formed on a fluoropolymer layer (hydrophobic insulating film) was visually observed in the course of production of the test cell. The degree of the observed density unevenness was evaluated according to the following evaluation criteria.

### <Evaluation Criteria>

A: Density unevenness was not observed.

B: Partial existence of repellence of the oil and density unevenness due to the repellence was observed.

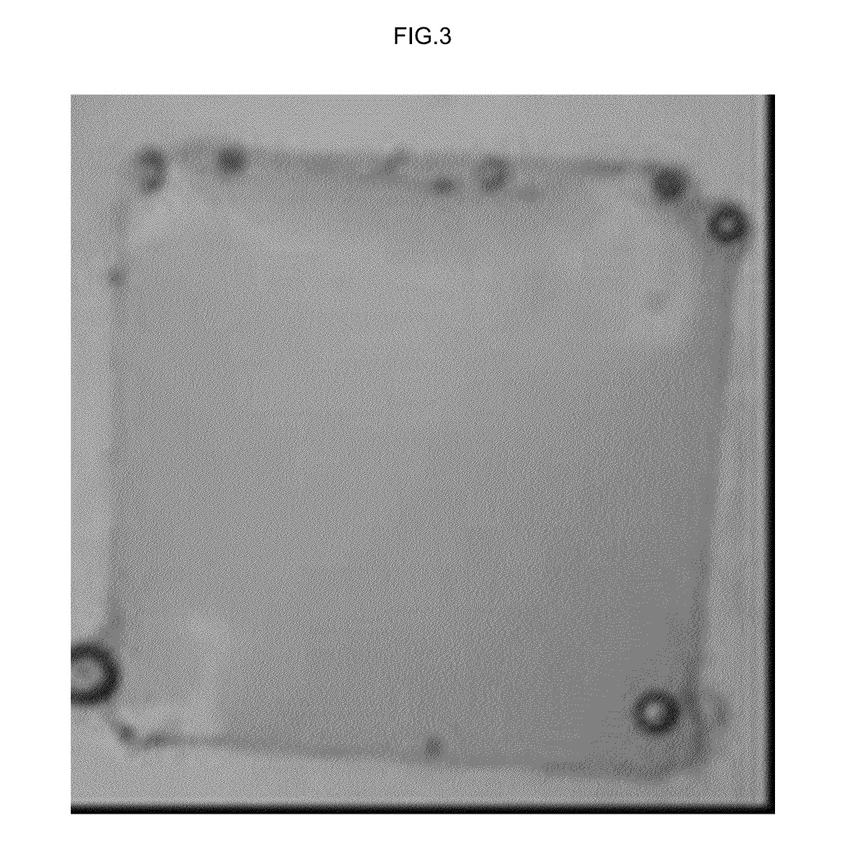

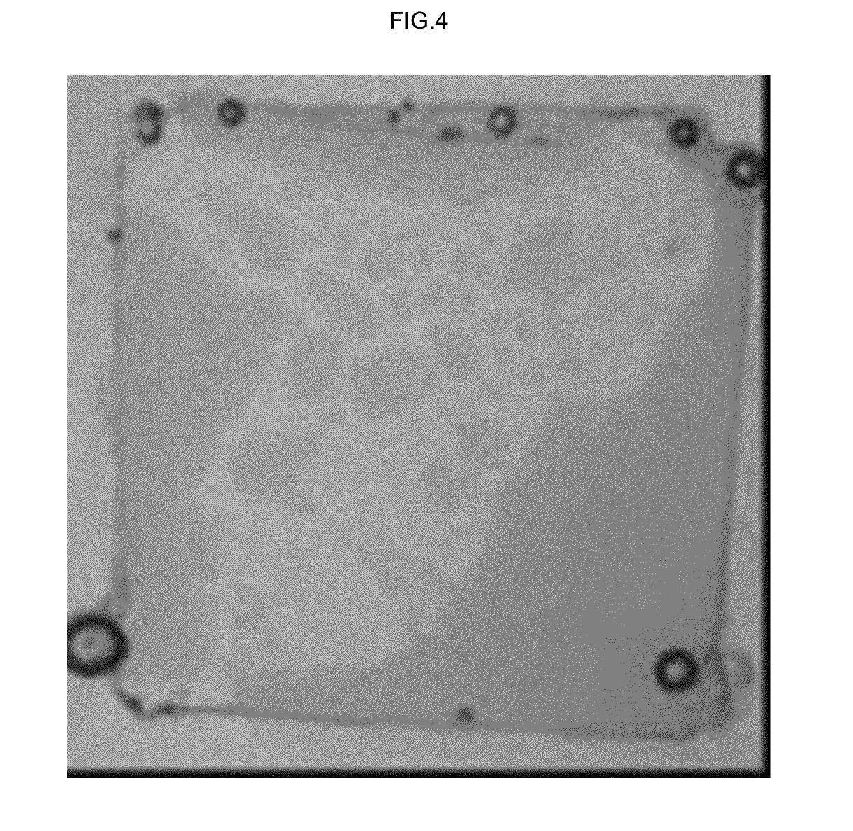

Electron micrographs of the test cells are shown in FIG. 3 and FIG. 4. FIG. 3 is a micrograph showing a status of the oil layer formed with the dye ink P1 of the Example on the fluoropolymer layer (hydrophobic insulating film), and FIG. 4 is a micrograph showing a status of the oil layer formed with the dye ink D1 of the comparative example on the fluoropolymer layer (hydrophobic insulating film).

As shown in FIG. 3, in the dye composition (oil) of the Example, repellence did not occur on the fluoropolymer layer (hydrophobic insulating film), and a highly uniform oil layer without density unevenness was formed. On the other hand, in the comparative dye composition, as shown in FIG. 4, the oil was repelled from the fluoropolymer layer and density unevenness occurred, so that a uniform oil layer could not be formed.

### (2) Responsiveness, and Backflow

To each of ITO films (transparent electrodes) of 2 glass substrates with an ITO film, a 100V direct current voltage was applied by a signal generator (a minus voltage was applied to the side of the ITO electrode on which a fluoropolymer layer (hydrophobic insulating film) was formed), and the display cell (display cell 30 in FIG. 2) was observed to confirm that the dye ink moved unidirectionally on a surface of the fluoropolymer layer and the covered area of the fluoropolymer layer reduced. The responsiveness of the dye ink in such a state and the degree of a backflow phenomenon in a state in which the voltage application was kept were evaluated.

The area reduction by voltage application was evaluated according to an area contraction ratio [%] calculated by the following Formula (1), and the backflow phenomenon was evaluated according to a backflow ratio [%] calculated by the following Formula (2), respectively.

a) Response time [msec]=Time required from initiation of voltage application up to maximum contraction, when voltage application was initiated from a state without voltage application

b) Area contraction ratio [%]=(Area of dye ink at maximum contraction)/(Area of dye ink before voltage application)×100 (1)

c) Backflow ratio [%]=(Area of dye ink 5 sec after initiation of voltage application)/(Area of dye ink at maximum contraction)×100 (2)

Further, as OD (image density), an OD value at the maximum absorption wave length was measured with a spectroradiometer SR-3 produced by Topcon Corporation and evaluated.

### (3) Optical Density

Each of the test cells using each dye composition (oil), the optical density per thickness of an oil layer (μm) in an image area of a black solid display was measured with an optical density meter (produced by Topcon Corporation).

TABLE 4
[Dye concentration: 20% by mass]

| | | | | Responsiveness | | | | |
|---|---|---|---|---|---|---|---|---|
| Dye | | | | Area | Response | Back | Optical | |
| ink | Dye | Solvent | Oil density | contraction | time | flow | density | |
| (oil) | kind | kind | unevenness | ratio [%] | [msec] | [%] | [/μm] | Remarks |
| P1 | P-1 | dihexyl | A | 12 | <200 | <105 | 0.5 | Present |
| | | ether | | | | | | invention |
| P2 | P-2 | dihexyl | A | 15 | <200 | <105 | 0.7 | Present |
| | | ether | | | | | | invention |
| P3 | P-3 | dihexyl | A | 15 | <200 | <105 | 0.7 | Present |
| | | ether | | | | | | invention |
| P4 | P-4 | dihexyl | A | 12 | <200 | 110 | 0.5 | Present |
| | | ether | | | | | | invention |
| P5 | P-5 | dihexyl | A | 12 | <200 | <105 | 0.8 | Present |
| | | ether | | | | | | invention |
| P6 | P-6 | dihexyl | A | 11 | <200 | <105 | 0.9 | Present |
| | | ether | | | | | | invention |
| P7 | P-1 | dipentyl | A | 12 | <200 | <105 | 0.5 | Present |
| | | ether | | | | | | invention |
| D1 | P-1 | n-decane | B | 12 | <200 | <105 | 0.4 | Comparative |

* Area contraction ratio 100% means a situation where no contraction occurs.

As shown in Table 4, in Examples where dihexyl ether or dipentyl ether was used as a nonpolar solvent, a highly uniform oil layer was formed and density unevenness was not observed. On the other hand, in the case of a comparative oil using n-decane as a comparative sample, a repellence of an oil layer in a test cell was recognized, and partial presence of density unevenness was confirmed. In other words, it has been confirmed that with an ether-based nonpolar solvent having a relative dielectric constant of 5 or less, a uniform oil thin film can be easily formed.

Further, a test cell using the oil according to Example (dye composition for an electrowetting display according to the invention) exhibited superior responsiveness, and a backflow phenomenon after image display (in a voltage application state) was also improved.

Further, it was confirmed that the optical density became higher in a case in which the oil according to Example was used, compared to a case in which the comparative oil was used.

Although in the above Examples, examples where dihexyl ether or dipentyl ether was used were mainly described, even when another “ether-based nonpolar solvent with a relative dielectric constant of 5 or less” is used, similar results can be obtained.

The disclosure of Japanese Patent Application No. 2012-259175 is hereby incorporated by reference herein in its entireties.

All the literature, patent literature, and technical standards cited herein are also herein incorporated to the same extent as provided for specifically and severally with respect to an individual literature, patent literature, and technical standard to the effect that the same should be so incorporated by reference.

What is claimed is:

1. A dye composition for an electrowetting display, comprising:
an ether-based nonpolar solvent having a relative dielectric constant of 5 or less; and
a dye at a content of 10% by mass or more with respect to a total mass of the dye composition.

2. The dye composition for an electrowetting display according to claim 1, wherein a boiling point of the ether-based nonpolar solvent is 180° C. or higher and a solidifying point of the ether-based nonpolar solvent is −40° C. or lower.

3. The dye composition for an electrowetting display according to claim 1, wherein the ether-based nonpolar solvent comprises a symmetric structure in a molecule thereof.

4. The dye composition for an electrowetting display according to claim 1, wherein the ether-based nonpolar solvent comprises dihexyl ether or dipentyl ether.

5. The dye composition for an electrowetting display according to claim 1, wherein the content of the dye is of 20% by mass or more with respect to the total mass of the dye composition.

6. The dye composition for an electrowetting display according to claim 1, wherein the dye has a structure comprising an alkyl group with from 6 to 30 carbon atoms.

7. The dye composition for an electrowetting display according to claim 1, wherein the dye is selected from the group consisting of an azo dye, an azomethine dye, a methine dye, a phthalocyanine dye, a porphyrin dye, and an anthraquinone dye.

8. An electrowetting display device, comprising:
a display unit comprising:
a first substrate comprising at least a part having electrically conductivity on at least one surface of the first substrate;
a second substrate that is positioned opposing the surface having electrical conductivity of the first substrate;
a hydrophobic insulating film that is provided on at least a part of a side of the surface having electrically conductivity of the first substrate;
the dye composition for an electrowetting display according to claim 1, which is provided between the hydrophobic insulating film and the second substrate, the dye being movable on the hydrophobic insulating film; and
an electrically conductive hydrophilic liquid that is provided between the hydrophobic insulating film and the second substrate, and that is provided in contact with the dye composition for an electrowetting display;
wherein an image is displayed by applying a voltage between the hydrophilic liquid and the surface having electrical conductivity of the first substrate, to change a shape of an interface between the dye composition for an electrowetting display and the hydrophilic liquid.

9. The dye composition for an electrowetting display according to claim 2, wherein the content of the dye is of 20% by mass or more with respect to the total mass of the dye composition.

10. The dye composition for an electrowetting display according to claim 1, wherein the ether-based nonpolar solvent comprises a dialkyl ether.

11. The dye composition for an electrowetting display according to claim 10, wherein the content of the dye is of 20% by mass or more with respect to the total mass of the dye composition.
